(19) United States
(12) Patent Application Publication
(10) Pub. No.: US 2014/0085353 A1
(43) Pub. Date: Mar. 27, 2014

(54) SEMICONDUCTOR INTEGRATED DEVICE, DISPLAY DEVICE, AND DEBUGGING METHOD FOR SEMICONDUCTOR INTEGRATED DEVICE

(71) Applicant: Shinsuke Yokonuma, Osaka-shi (JP)

(72) Inventor: Shinsuke Yokonuma, Osaka-shi (JP)

(73) Assignee: SHARP KABUSHIKI KAISHA, Osaka-shi, Osaka (JP)

(21) Appl. No.: 14/124,262

(22) PCT Filed: May 30, 2012
(86) PCT No.: PCT/JP2012/063874

§ 371 Date: Dec. 6, 2013

(30) Foreign Application Priority Data
Jun. 17, 2011 (JP) 2011-134898

(51) Int. Cl. G09G 3/36

(52) U.S. Cl. CPC G09G 3/3607
USPC 345/690; 345/204; 345/87

(57) ABSTRACT

Provided is a semiconductor integrated device that supports a high-speed serial interface specification and allows easy debugging to be performed at low cost.

An LCD driver (20) is equipped with a display control circuit-side DSI interface (211) and a display control circuit-side single-ended interface (212). A debug mode 0 command is issued through a DSI bus (L1) connected to the display control circuit-side DSI interface (211), and preparations are made to connect a test device (500) to a single-ended bus (L2) connected to the display control circuit-side single-ended interface (212). Thereafter, a debug mode ON command is issued through the DSI bus (L1), so that the operation mode of a display control circuit (200) transitions to a debug mode. In the debug mode, debugging is performed using a signal transmitted through the single-ended bus (L2).

### TECHNICAL FIELD

The present invention relates to semiconductor integrated devices, display devices, and debugging methods for semiconductor integrated devices, particularly to a semiconductor integrated device that supports the DSI (Display Serial Interface) specification, a display device including the semiconductor integrated device, and a debugging method for the semiconductor integrated device.

### BACKGROUND ART

The display data transmission interface for display devices, such as liquid crystal display devices, is experiencing a transition from the parallel transmission method, which requires a number of signal lines, to the serial transmission method, which requires a smaller number of signal lines. The serial transmission method is extremely important in particular to mobile devices, such as cell phones, in which wiring space is required to be reduced.

In recent years, the DSI (Display Serial Interface) has been attracting attention as a high-speed serial interface. The DSI is a specification proposed by the MIPI (Mobile Industry Processor Interface) Alliance. The DSI allows data transmission in a high-speed (HS) differential signaling mode and data transmission in a low-power (LP) single-ended signaling mode. The HS mode is used for transmitting image data, etc., at high speed, and the LP mode is used for transmitting a control signal (command). Note that a semiconductor integrated device that supports the DSI specification is described in, for example, Patent Document 1.

When compared to conventional interfaces, signals transmitted in accordance with the DSI specification are more complicated and have higher frequencies. Therefore, debugging a driver for a liquid crystal display device that supports the DSI specification requires a waveform analysis using more expensive facilities and equipment than conventional. Moreover, such an analysis requires more time than conventional.

In relevance to the present invention, Patent Document 2 discloses a high-speed serial controller equipped with a test circuit. The test circuit is connected to interface portions between PHY (physical layer) circuits and LINC (data link layer) circuits. This high-speed serial controller allows debugging through direct observation of parallel data transmitted through the interface portions using a serial test interface connectable to an external device.

### CITATION LIST

### Patent Documents

Patent Document 1: Japanese Laid-Open Patent Publication No. 2011-90252

Patent Document 2: Japanese Laid-Open Patent Publication No. 2004-271282

Patent Document 3: Japanese Laid-Open Patent Publication No. 7-254037

### SUMMARY OF THE INVENTION

### Problems to be Solved by the Invention

However, the high-speed serial controller described in Patent Document 2 requires the test circuit and the serial test interface dedicated to debugging, which leads to an increase in cost.

Therefore, an objective of the present invention is to provide a semiconductor integrated device, a display device, and a debugging method for a semiconductor integrated device which support a high-speed serial interface specification, and allow easy debugging to be achieved at low cost.

### Solution to the Problems

A first aspect of the present invention is directed to a semiconductor integrated device comprising:

a display control portion for controlling image display on an external display panel, wherein,

the display control portion includes:
a first interface connected to a first bus connectable to an external device, the first interface being capable of serially receiving a signal group transmitted through the first bus and consisting of a differential signal and a first single-ended signal; and
a signal processing portion connected to the first interface for generating a control signal and an image signal on the basis of the signal group received by the first interface, the control signal controlling image display on the display panel, the image signal corresponding to an image to be displayed on the display panel,

the first interface is capable of receiving a first command to switch operation modes of the display control portion, the first command being issued through the first bus by an external host connected to the first bus, and

the operation mode of the display control portion transitions to a debug mode allowing debugging to be performed without using the first bus, in accordance with the first command.

In a second aspect of the present invention, based on the first aspect of the invention, the first interface is an interface based on the DSI specification.

In a third aspect of the present invention, based on the first aspect of the invention, the display control portion further includes a second interface connected to a second bus connectable to an external device, the second interface being capable of receiving a second single-ended signal transmitted through the second bus, and in the debug mode, the debugging is allowed to be performed using a signal transmitted through the second bus, in accordance with a second command issued through the second bus.

In a fourth aspect of the present invention, based on the third aspect of the invention, the second interface includes a serial interface capable of serially receiving the second single-ended signal.

In a fifth aspect of the present invention, based on the fourth aspect of the invention, the serial interface is an interface based on the SPI specification.

In a sixth aspect of the present invention, based on the fourth aspect of the invention, the serial interface is an interface based on the I2C specification.

In a seventh aspect of the present invention, based on the third aspect of the invention, the second interface includes a parallel interface capable of receiving the second single-ended signal in parallel.

In an eighth aspect of the present invention, based on the first aspect of the invention, the signal processing portion includes a register for storing command data to control an operation of the signal processing portion, the data being received from the host via the first interface, and an image signal generating portion for generating the image signal, and the image signal generating portion includes an image processing portion for generating the image signal on the basis of image signal generation data for use in generating the image signal, and a first selector for providing the image signal generation data to the image processing portion, the image signal generation data being the command data when the operation mode of the display control portion is the debug mode, and the image signal generation data being data received from the host via the first interface and corresponding to the image to be displayed on the display panel when the operation mode of the display control portion is not the debug mode.

In a ninth aspect of the present invention, based on the eighth aspect of the invention, the image processing portion corrects the image signal generation data in accordance with a predetermined setting, the image signal generating portion further includes a second selector using a first setting as the predetermined setting when the operation mode of the display control portion is the debug mode, and using a second setting as the predetermined setting when the operation mode of the display control portion is not the debug mode, the first setting is a setting for correcting the image signal generation data into data in at least two colors, and the second setting is a setting for correcting a gray-scale level of the image signal generation data on the basis of gamma characteristics of the display panel.

In a tenth aspect of the present invention, based on the eighth aspect of the invention, the image signal generating portion further includes a two-dimensional code conversion portion for converting the command data to be provided to the image processing portion via the first selector into a two-dimensional code.

In an eleventh aspect of the present invention, based on any one of the first through tenth aspects of the invention, the semiconductor integrated device further comprises a drive portion connected to the display control portion for driving the display panel on the basis of the control signal and the image signal.

A twelfth aspect of the present invention is directed to a display device comprising:

a semiconductor integrated device of the eleventh aspect of the invention; and

the display panel.

A thirteenth aspect of the present invention is directed to a display device comprising:

a semiconductor integrated device of any one of the first through tenth aspects;

the display panel; and

a drive portion connected to the display control portion for driving the display panel on the basis of the control signal and the image signal.

A fourteenth aspect of the present invention is directed to a debugging method for a semiconductor integrated device comprising a display control portion including a first interface connected to a first bus connectable to an external device, and a signal processing portion connected to the first interface, the first interface being capable of serially receiving a signal group transmitted through the first bus and consisting of a differential signal and a first single-ended signal, the signal processing portion generating a control signal and an image signal on the basis of the signal group received by the first interface, the control signal controlling image display on an external display panel, the image signal corresponding to an image to be displayed on the display panel, the method comprising the steps of:

receiving a first command to switch operation modes of the display control portion, the first command being issued through the first bus by an external host connected to the first bus; and

causing the operation mode of the display control portion to transition to a debug mode allowing debugging to be performed without using the first bus, in accordance with the first command.

In a fifteenth aspect of the present invention, based on the fourteenth aspect of the invention, the display control portion further includes a second interface connected to a second bus connectable to an external device, the second interface being capable of receiving a second single-ended signal transmitted through the second bus, and the method further comprises the step of, when the operation mode of the display control portion is the debug mode, performing the debugging using a signal transmitted through the second bus, in accordance with a second command issued through the second bus.

In a sixteenth aspect of the present invention, based on the fourteenth aspect of the invention, the signal processing portion includes a register for storing command data to control an operation of the signal processing portion, the data being received from the host via the first interface, and the method further comprises the step of generating the image signal on the basis of the command data when the operation mode of the display control portion is the debug mode, and on the basis of data received from the host via the first interface and corresponding to the image to be displayed on the display panel when the operation mode of the display control portion is not the debug mode.

### Effect of the Invention

In the first aspect of the present invention, the semiconductor integrated device is equipped with the first interface capable of serially receiving the signal group transmitted through the first bus and including a differential signal and a first single-ended signal, and the semiconductor integrated device enables transitioning to the debug mode that allows debugging to be performed without using the first bus. Thus, easy debugging can be achieved at low cost in the debug mode without analyzing complicated waveforms of a signal group.

The second aspect of the present invention allows easy debugging to be achieved at low cost in the debug mode without analyzing complicated waveforms of a signal group transmitted through the first bus connected to an interface based on the DSI specification.

The third aspect of the present invention allows the debugging to be performed using a signal transmitted through the second bus in the debug mode without analyzing complicated waveforms of a signal group transmitted through the first bus connected to an interface based on the DSI specification.

The fourth aspect of the present invention allows the debugging to be performed using a signal transmitted through the second bus connected to a serial interface.

The fifth aspect of the present invention allows the debugging to be performed using a signal transmitted through the second bus connected to a serial interface based on the SPI specification.

The sixth aspect of the present invention allows the debugging to be performed using a signal transmitted through the second bus connected to a serial interface based on the I2C specification.

The seventh aspect of the present invention allows the debugging to be performed using a signal transmitted through the second bus connected to a parallel interface.

In the eighth aspect of the present invention, command data stored in the register is displayed in the debug mode as an image on an external display panel. Thus, easy debugging can be achieved at low cost by visually checking the image or reading the image with a scanner or suchlike.

In the ninth aspect of the present invention, the second selector switches the setting for correcting image signal generation data between the first and second settings, on the basis of whether the debug mode is enabled or not. Thus, image display can be provided reliably both in the debug mode and in any mode other than the debug mode.

In the tenth aspect of the present invention, in the debug mode, a two-dimensional code is displayed on an external display panel. The two-dimensional code can be readily read with a scanner or suchlike. Thus, when compared to the eighth invention, the debugging can be performed more readily.

In the eleventh aspect of the present invention, the semiconductor integrated device further including a drive portion is allowed to achieve an effect similar to that achieved by any of the first through tenth aspects of the invention.

The twelfth aspect of the present invention allows the display device to achieve an effect similar to that achieved by the eleventh aspect of the invention.

The thirteenth aspect of the present invention allows the display device to achieve an effect similar to that achieved by any of the first through tenth aspects of the invention.

The fourteenth through sixteenth aspects of the present invention allow the debugging methods for semiconductor integrated devices to achieve effects similar to those achieved by the first, third, and eighth aspects, respectively, of the invention.

### BRIEF DESCRIPTION OF THE DRAWINGS

FIG. 1 is a block diagram describing the overall configuration of a liquid crystal display device according to a first embodiment of the present invention.

FIG. 2 is a block diagram describing the configuration of a display control circuit in the first embodiment.

FIG. 3 is a block diagram describing the configuration of a host input/output portion in the first embodiment.

FIG. 4 is a block diagram describing the configuration of a display control circuit-side single-ended interface in the first embodiment.

FIG. 5 is a block diagram illustrating the configuration of a DSI-bus transmission circuit in the first embodiment.

FIG. 6 is a signal waveform diagram describing data transmission in a high-speed mode by a DSI-bus transmission circuit in the first embodiment.

FIG. 7 is a signal waveform diagram describing data transmission in a low-power mode by a DSI-bus transmission circuit in the first embodiment.

FIG. 8 is a signal waveform diagram describing switching between the high-speed mode and the low-power mode by the DSI-bus transmission circuit in the first embodiment.

FIG. 9 is a schematic diagram describing a display operation using the DSI-bus transmission circuit in the first embodiment.

FIG. 10 is a block diagram illustrating the configuration of an SPI-bus transmission circuit in the first embodiment.

FIG. 11 is a signal waveform diagram describing signal transmission through the SPI-bus transmission circuit in the first embodiment.

FIG. 12 is a block diagram illustrating the configuration of an I2C-bus transmission circuit in the first embodiment.

FIG. 13 is a signal waveform diagram describing signal transmission through the I2C-bus transmission circuit in the first embodiment.

FIG. 14 is a flowchart describing the steps for a transition from normal to debug mode in the first embodiment.

FIG. 15 is a scheme describing the status of each bus at the transition from normal to debug mode in the first embodiment.

FIG. 16 is a block diagram describing connections to a test device in the first embodiment.

FIG. 17 is a diagram showing the correspondence between terminals and buses in a practical example of the first embodiment.

FIG. 18 is a block diagram illustrating in part an example of the wiring in the practical example of the first embodiment.

FIG. 19 is a schematic diagram illustrating a pattern on a flexible printed circuit in the practical example of the first embodiment.

FIG. 20 is a block diagram describing the configuration of a display control circuit-side single-ended interface in a variant of the first embodiment.

FIG. 21 is a block diagram illustrating the configuration of a parallel bus transmission circuit in the variant of the first embodiment.

FIG. 22 is a signal waveform diagram describing signal transmission through the parallel bus transmission circuit in the variant of the first embodiment.

FIG. 23 is a block diagram describing the configuration of a host input/output portion in a second embodiment of the present invention.

FIG. 24 is a block diagram illustrating the configuration of an image signal generating portion in the second embodiment.

FIG. 25 is a schematic diagram showing a display example of register data in the second embodiment.

FIG. 26 is a diagram showing the correspondence between sets of three bits in register data and colors to be assigned in the variant of the second embodiment.

FIG. 27 is a schematic diagram showing a display example of register data in the variant of the second embodiment.

FIG. 28 is a block diagram illustrating the configuration of an image signal generating portion in a third embodiment of the present invention.

FIG. 29 is a schematic diagram showing a display example of register data in the third embodiment.

### MODES FOR CARRYING OUT THE INVENTION

Hereinafter, embodiments of the present invention will be described with reference to the accompanying drawings.

### 1. First Embodiment

<1.1 Overall Configuration of the Liquid Crystal Display Device>

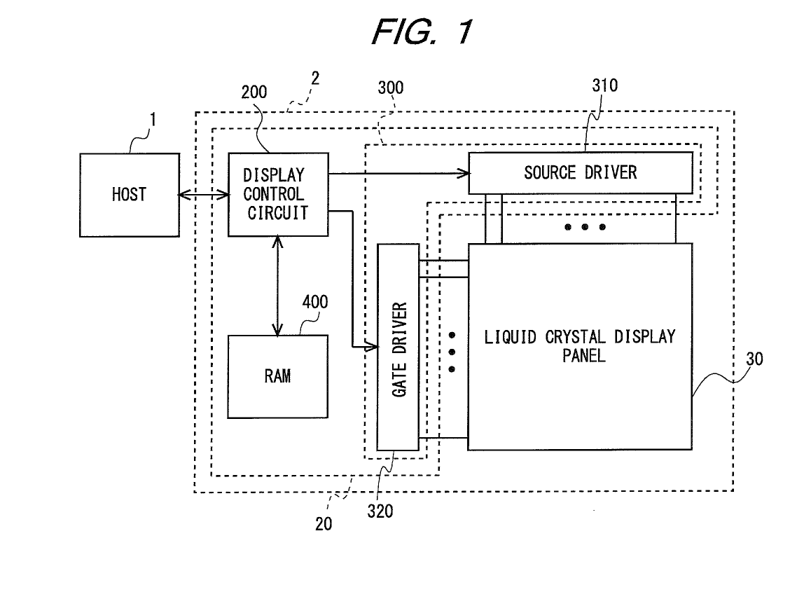

FIG. 1 is a block diagram describing the overall configuration of a liquid crystal display device according to a first embodiment of the present invention. The liquid crystal display device 2 according to the present embodiment includes an LCD (Liquid Crystal Display) driver 20 serving as a semiconductor integrated device, and a liquid crystal display panel 30, as shown in FIG. 1. The LCD driver 20 (more specifically, a display control circuit 200 in the LCD driver 20 to be described later) is capable of operating in two operation modes, normal and debug, as will be described later. Moreover, the LCD driver 20 is realized as an IC (Integrated Circuit) including the display control circuit 200 (display control portion), a driver group (drive portion) 300, and RAM (Random Access Memory) 400. The driver group 300 includes a source driver 310 and a gate driver 320. A host 1, which is a CPU (Central Processing Unit), is provided outside the liquid crystal display device 2. The host 1 is connected to the display control circuit 200. The liquid crystal display device 2 according to the present embodiment and the host 1 are provided in an electronic device (e.g., a mobile electronic device).

Note that in the present embodiment, the display control circuit 200, the source driver 310, the gate driver 320, and the RAM 400 are formed as a single IC, as described above, but the present invention is not limited to this. For example, either or both of the source driver 310 and the gate driver 320 may be formed as an IC independently of the display control circuit 200. Moreover, either or both of the source driver 310 and the gate driver 320 may be integrally formed with the liquid crystal display panel 30 using, for example, amorphous silicon, polycrystalline silicon, microcrystalline silicon, or an oxide semiconductor (e.g., IGZO).

Furthermore, in the present embodiment, the RAM 400 is provided in the liquid crystal display device 2, more specifically, in the LCD driver 20, but the RAM 400 may be provided outside the liquid crystal display device 2.

The liquid crystal display panel 30 has formed thereon n source lines (video signal lines) SL₁ to SLₙ, m gate lines (scanning signal lines) GL₁ to GLₘ, and m×n pixel forming portions provided so as to correspond to respective intersections of the source lines SL₁ to SLₙ and the gate lines. The pixel forming portions are arranged in a matrix to constitute pixel arrays. Each pixel forming portion includes a thin-film transistor, which is a switching element having a gate terminal connected to the gate line that passes through its corresponding intersection and a source terminal connected to the source line that passes through the intersection, a pixel electrode connected to a drain terminal of the thin-film transistor, a common electrode Ec, which is an opposing electrode commonly provided for the pixel forming portions, and a liquid crystal layer commonly provided for the pixel forming portions between the pixel electrode and the common electrode Ec. Moreover, pixel capacitance Cp is created by a liquid crystal capacitor formed by the pixel electrode and the common electrode Ec. Note that typically, to reliably hold a voltage in the pixel capacitance Cp, an auxiliary capacitor is provided parallel to the liquid crystal capacitor.

The display control circuit 200 receives a signal group SG transmitted by the host 1 via a DSI bus circuit to be described later, and outputs an image signal DV, which corresponds to an image to be displayed on the liquid crystal display panel 30, and control signals CS to control image display on the liquid crystal display panel 30. The control signals CS include, for example, a source start pulse signal SSP, a source clock signal SCK, a latch strobe signal LS, a gate start pulse signal GSP, a gate-end pulse signal GEP, and a gate clock signal GCK. The display control circuit 200 will be described in detail later.

The source driver 310 receives the image signal DV, the source start pulse signal SSP, the source clock signal SCK, and the latch strobe signal LS outputted by the display control circuit 200, and applies video signals SS(1) to SS(n) to the source lines SL₁ to SLₙ, respectively.

On the basis of the gate start pulse signal GSP, the gate-end pulse signal GEP, and the gate clock signal GCK outputted by the display control circuit 200, the gate driver 320 repeats application of active scanning signals GOUT(1) to GOUT(m) to the gate bus lines GL₁ to GLₘ, respectively, in cycles of one vertical scanning period.

In this manner, the video signals SS(1) to SS(n) are applied to the source lines SL₁ to SLₙ, respectively, and the scanning signals GOUT(1) to GOUT(m) are applied to the gate lines GL₁ to GLₘ, respectively, so that an image based on the image signal DV is displayed on the liquid crystal display panel 30.

<1.2 Configuration of the Display Control Circuit>

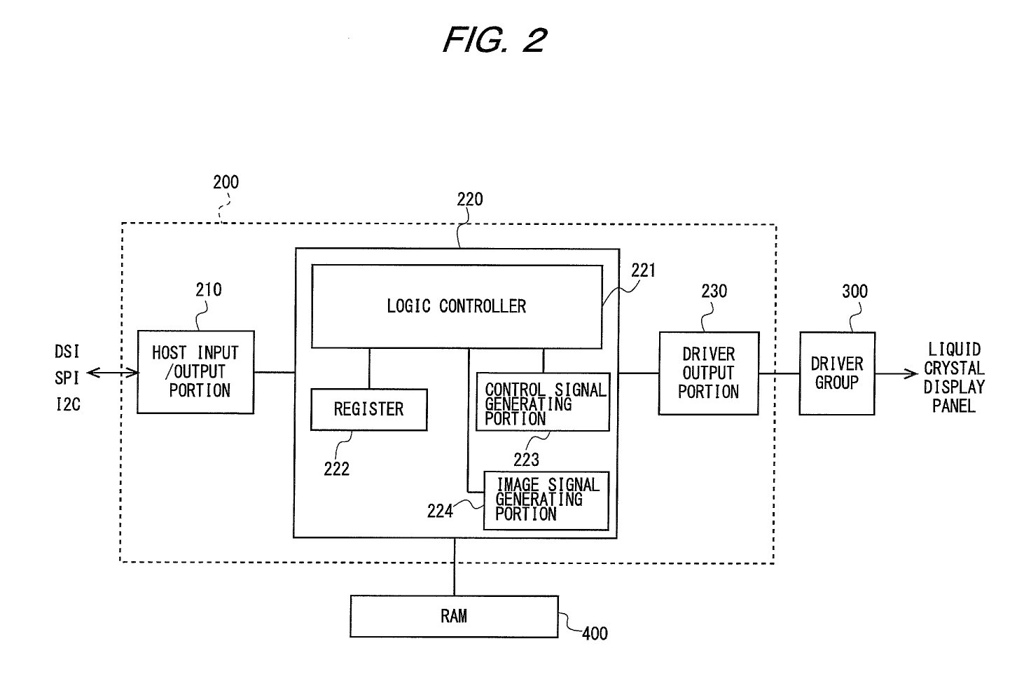

FIG. 2 is a block diagram describing the configuration of the display control circuit 200 in the present embodiment. The display control circuit 200 in the present embodiment includes a host input/output portion 210, a signal processing portion 220, and a driver output portion 230, as shown in FIG. 2. The host input/output portion 210 is connected to the signal processing portion 220, and the signal processing portion 220 is connected to the driver output portion 230. Moreover, the signal processing portion 220 is connected to the RAM 400, and the driver output portion 230 is connected to the driver group 300.

The host input/output portion 210 is connected to the external host 1. The display control circuit 200 receives the signal group SG from the host 1 via the host input/output portion 210. The signal group SG includes image data DAT and command data COM. The host input/output portion 210 will be described in detail later.

In accordance with the image data DAT and the command data COM received from the host 1, the signal processing portion 220 generates an image signal DV and control signals CS to control the operation of the source driver 310 and the gate driver 320 included in the driver group 300. The signal processing portion 220 includes a logic controller 221, a register 222, a control signal generating portion 223, and an image signal generating portion 224.

The driver output portion 230 outputs the image signal DV and the control signals CS generated by the signal processing portion 220 to the driver group 300.

The RAM 400 connected to the signal processing portion 220 functions as both a frame buffer for image display and a working area for the signal processing portion 220.

The operation of the display control circuit 200 will now be further described. The display control circuit 200 receives the image data DAT and the command data COM from the host 1 via the host input/output portion 210, as described above. The image data DAT is data corresponding to an image to be displayed on the liquid crystal display panel 30. More specifically, the image data DAT is data corresponding to an image to be displayed on the liquid crystal display panel 30 in a normal mode to be described later. The command data COM is data for use in, for example, setting the contents in the register 222 to control the driver group 300 (source driver 310 and gate driver 320) and also setting the operation mode (normal or debug mode) of the display control circuit 200.

Upon reception of the image data DAT, the display control circuit 200 stores the image data DAT to the RAM 400 functioning as a frame buffer. On the other hand, upon reception of the command data COM, the display control circuit 200 stores the command data COM to the register 222 (the data may be stored to the RAM 400).

In accordance with the contents set in the register 222, the logic controller 221 causes the control signal generating portion 223 to generate control signals CS and a timing signal TS to time the image signal generating portion 224 to generate an image signal. Moreover, the logic controller 221 causes the image signal generating portion 224 to generate an image signal DV. In accordance with the timing signal TS generated by the control signal generating portion, the image signal generating portion 224 generates the image signal DV by subjecting the image data DAT stored in the RAM 400 to, for example, a gray-level correction based on the gamma characteristics of the liquid crystal display panel 30. In addition, the logic controller 221 outputs the generated image signal DV and the control signals CS to the driver group 300 (source driver 310 and gate driver 320) via the driver output portion 230.

<1.3 Configuration of the Host Input/Output Portion>

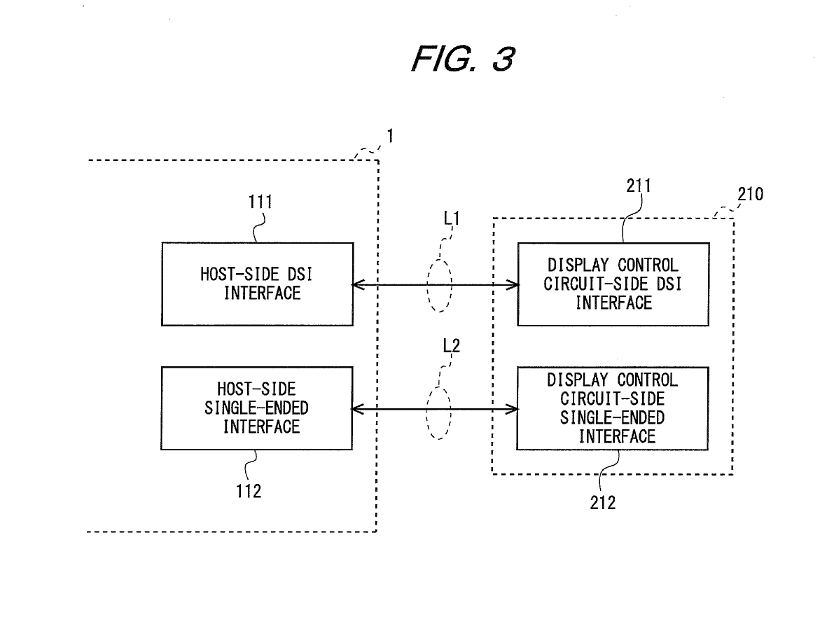

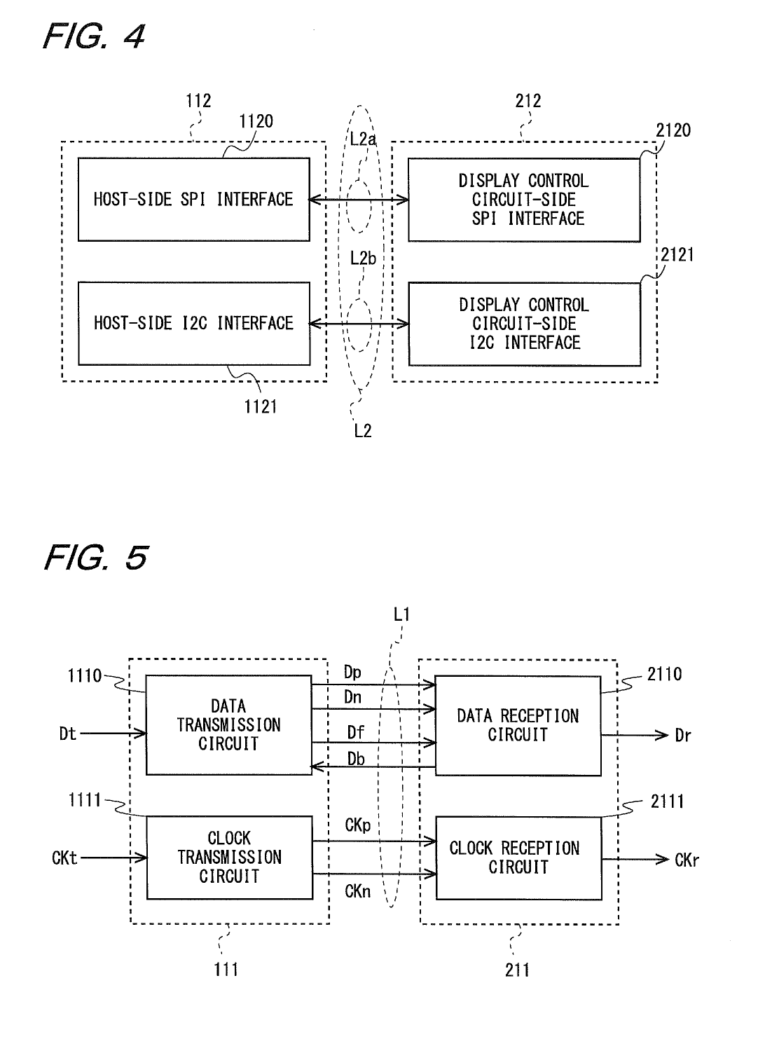

FIG. 3 is a block diagram describing the configuration of the host input/output portion 210 in the present embodiment. The host input/output portion 210 in the present embodiment includes a display control circuit-side DSI interface (first interface) 211 and a display control circuit-side single-ended interface (second interface) 212, as shown in FIG. 3. The display control circuit-side DSI interface 211 is a serial interface based on the DSI (Display Serial Interface) specification. The display control circuit-side single-ended interface 212 includes a display control circuit-side SPI interface 2120 and a display control circuit-side I2C interface 2121, as shown in FIG. 4. The display control circuit-side SPI interface 2120 is a serial interface based on the SPI (Serial Peripheral Interface) specification. The display control circuit-side I2C interface 2121 is a serial interface based on the I2C (Inter-Integrated Circuit or I-squared-C) specification.

The host 1 has provided therein a host-side DSI interface 111 and a host-side single-ended interface 112, as shown in FIG. 3. The host-side DSI interface 111 is a serial interface based on the DSI specification. The host-side single-ended interface 112 includes a host-side SPI interface 1120 and a host-side I2C interface 1121, as shown in FIG. 4. The host-side SPI interface 1120 is an interface based on the SPI specification. The host-side I2C interface 1121 is an interface based on the I2C specification.

The host-side DSI interface 111 and the display control circuit-side DSI interface 211 are connected to each other by a DSI bus (first bus) L1, as shown in FIG. 3. The host-side DSI interface 111, the DSI bus L1, and the display control circuit-side DSI interface 211 realize a DSI-bus transmission circuit. Moreover, the host-side single-ended interface 112 and the display control circuit-side single-ended interface 212 are connected to each other by a single-ended bus (second bus) L2, as shown in FIG. 3. More specifically, the single-ended bus L2 consists of an SPI bus L2a and an I2C-bus L2b, as shown in FIG. 4.

The SPI bus L2a connects the host-side SPI interface 1120 and the display control circuit-side SPI interface 2120. The host-side SPI interface 1120, the SPI bus L2a, and the display control-side SPI interface realize an SPI-bus transmission circuit. Note that the SPI-bus transmission circuit is a transmission circuit for use in the debug mode to be described later, and therefore, the host-side SPI interface 1120 and the display control circuit-side SPI interface 2120 are not necessarily connected at all times, but they are connected at least during the debug mode.

The I2C-bus L2b connects the host-side I2C interface 1121 and the display control circuit-side I2C interface 2121. The host-side I2C interface 1121, the I2C-bus L2b, and the display control circuit-side I2C interface 2121 realize an I2C-bus transmission circuit. Note that, as with the SPI-bus transmission circuit, the I2C-bus transmission circuit is a transmission circuit for use in the debug mode to be described later, and therefore, the host-side I2C interface 1121 and the display control circuit-side I2C interface 2121 are not necessarily connected at all times, but they are connected at least during the debug mode.

The DSI-bus transmission circuit is used in the normal mode to be described later, and the SPI-bus transmission circuit or the I2C-bus transmission circuit is used in the debug mode to be described later. However, the LCD driver 20 (display control circuit 200) in the present embodiment is designed such that it can operate in the same manner as in the normal mode to be described later, using either the SPI-bus transmission circuit or the I2C-bus transmission circuit.

<1.4 DSI-Bus Transmission Circuit>

FIG. 5 is a block diagram illustrating the configuration of the DSI-bus transmission circuit in the present embodiment. The DSI-bus transmission circuit consists of the host-side DSI interface 111, the DSI bus L1, and the display control circuit-side DSI interface 211, as described earlier. The host-side DSI interface 111 includes a data transmission circuit 1110 and a clock transmission circuit 1111, as shown in FIG. 5. The display control circuit-side DSI interface 211 consists of a data reception circuit 2110 and a clock reception circuit 2111. The DSI-bus transmission circuit is capable of data transmission in a high-speed (HS) differential signaling mode and data transmission in a low-power (LP) single-ended signaling mode.

<1.4.1 HS Mode>

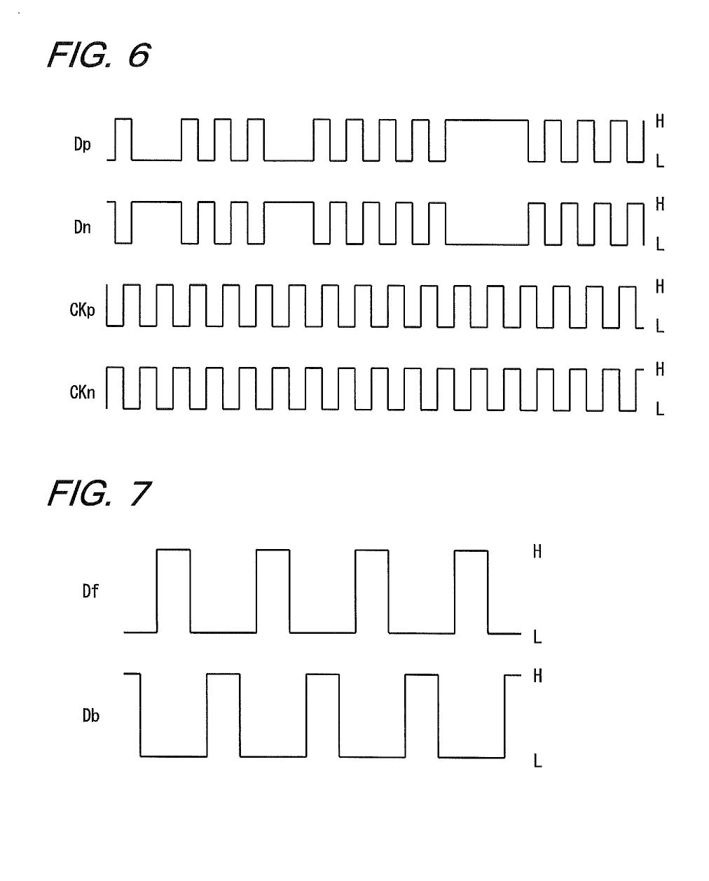

FIG. 6 is a signal waveform diagram describing data transmission in the HS mode by the DSI-bus transmission circuit. In the HS mode, the data transmission circuit 1110 transmits data differential signals Dp/Dn to the data reception circuit 2110, for example, with a voltage amplitude of 100 mV to 300 mV and at a frequency of about 200 MHz to 500 MHz. Moreover, the clock transmission circuit 1111 transmits clock differential signals CKp/CKn to the clock reception circuit 2111, for example, with a voltage amplitude of 100 mV to 300 mV and at a frequency of about 100 MHz, the clock differential signals CKp/CKn corresponding to a reception clock CKr to be described later, which is provided in order for reception data Dr converted from the differential signals, as will be described later, to be inputted to the signal processing portion 220. Note that the data differential signals Dp/Dn are inputted to the signal processing portion 220 both at the rising and falling edges of the clock differential signals CKp/CKn, and therefore, if the frequency of the clock differential signals CKp/CKn is 100 MHz, the data transfer rate is 200 Mbps.

Once transmission data Dt (typically, image data DAT) is provided to the data transmission circuit 1110, the data transmission circuit 1110 converts the transmission data Dt into data differential signals Dp/Dn, and transmits the signals to the data reception circuit 2110 via the DSI bus L1. The data reception circuit 2110 converts the received data differential signals Dp/Dn into reception data Dr, and outputs the data. The reception data Dr is provided to the signal processing portion 220. Likewise, once a transmission clock CKt is provided to the clock transmission circuit 1111, the clock transmission circuit 1111 converts the transmission clock CKt into clock differential signals CKp/CKn, and transmits the signals to the clock reception circuit 2111 via the DSI bus L1. The clock reception circuit 2111 converts the received clock differential signals CKp/CKn into a reception clock CKr, and outputs the clock. The reception clock CKr is provided to the signal processing portion 220.

The HS mode is mainly intended for transmission of the image data DAT. However, the command data COM may be transmitted in the HS mode.

<1.4.2 LP Mode>

FIG. 7 is a signal waveform diagram describing data transmission in the LP mode by the DSI-bus transmission circuit. In the LP mode, the data transmission circuit 1110 transmits a first single-ended data signal Df and a second single-ended data signal Db to the data reception circuit 2110, for example, with a voltage amplitude of 1.2 V and at a frequency of about 10 MHz. The first single-ended data signal Df corresponds to, for example, command data COM transmitted from the host 1 to the display control circuit 200, and the second single-ended data signal Db corresponds to, for example, command data COM transmitted from the display control circuit 200 to the host 1. The LP mode is not affected by the status of a transmission path through which the clock differential signals CKp/CKn are transmitted, and typically, the clock differential signals CKp/CKn are stopped from being transmitted (i.e., the potential is fixed).

The DSI-bus transmission circuit transmits data over transmission paths commonly used in the HS mode and the LP mode. In transmission of the first single-ended data signal Df in the LP mode, for example, the transmission path (referred to below as the “Dp line”) intended for transmission of the positive half of the data differential signals Dp/Dn, i.e., the data differential signal Dp, is used. Moreover, in transmission of the second single-ended data signal Db in the LP mode, for example, the transmission path (referred to below as the “Dn line”) intended for transmission of the negative half of the data differential signals Dp/Dn, i.e., the data differential signal Dn, is used. Thus, the number of signal lines of the DSI-bus transmission circuit can be reduced.

<1.4.3 Switching between HS Mode and LP Mode>

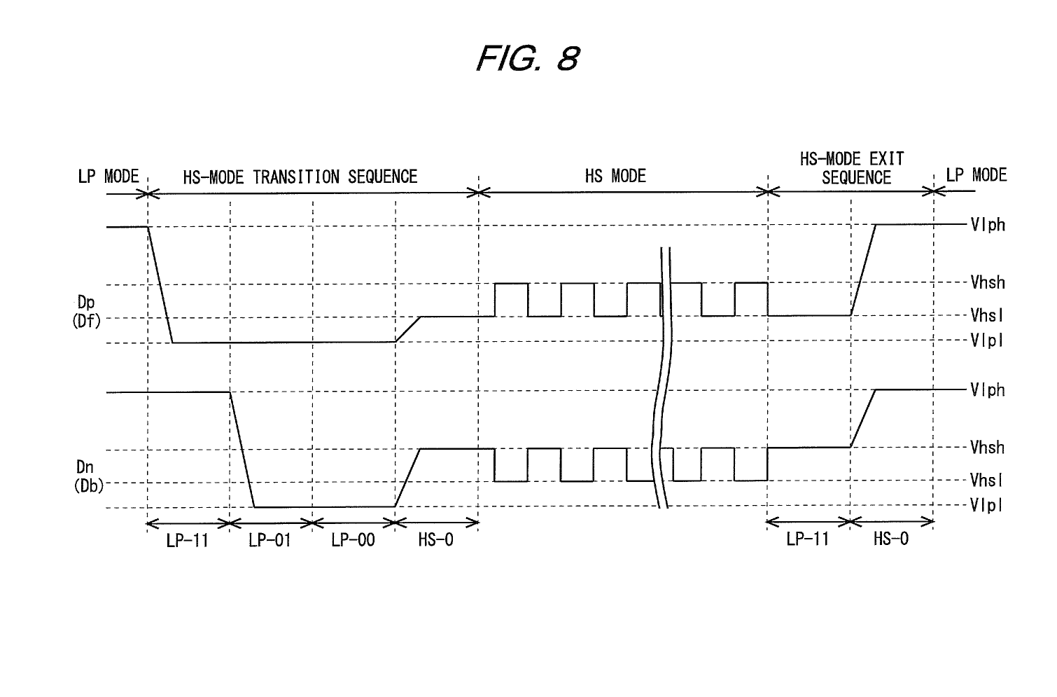

FIG. 8 is a signal waveform diagram describing the switching between the HS mode and the LP mode by the DSI-bus transmission circuit. In FIG. 8, Vhsh and Vhsl denote high-level and low-level potentials, respectively, in the HS mode, and Vlph and Vlpl denote high-level and low-level potentials, respectively, in the LP mode. Moreover, in FIG. 8, the upper portion provides a signal waveform chart for the Dp line, and the lower portion provides a signal waveform chart for the Dn line.

Transitioning from the LP mode to the HS mode is realized by an HS-mode transition sequence. The HS-mode transition sequence consists of periods LP-11, LP-01, LP-00, and HS-0. In the HS-mode transition sequence, the Dp line experiences a change from the LP-mode high-level potential Vlph to the LP-mode low-level potential Vlpl during period LP-11, the LP-mode low-level potential Vlpl is maintained during periods LP-01 and LP-00, and a change from the LP-mode low-level potential Vlpl to the HS-mode low-level potential Vhsl occurs during period HS-0. On the other hand, in the HS-mode transition sequence, the Dn line is at the LP-mode high-level potential Vlph during period LP-11, a change from the LP-mode high-level potential Vlph to the LP-mode low-level potential Vlpl occurs during period LP-01, the LP-mode low-level potential Vlpl is maintained during period LP-00, and a change from the LP-mode low-level potential Vlpl to the HS-mode high-level potential Vhsh occurs during period HS-0. After the HS-mode transition sequence, data transmission through the Dp line and the Dn line is performed in the HS mode.

Transitioning from the HS mode to the LP mode is realized by an HS-mode exit sequence. The HS-mode exit sequence is realized by periods HS-0 and LP-11. In the HS-mode exit sequence, the Dp line is at the HS-mode low-level potential Vhsl during period HS-0, and experiences a change from the HS-mode low-level potential Vhsl to the LP-mode high-level potential Vlph during period LP-11. On the other hand, in the HS-mode exit sequence, the Dn line is at the HS-mode high-level potential Vhsh during period HS-0, and experiences a change from the HS-mode high-level potential Vhsh to the LP-mode high-level potential Vlph during period LP-11. After the HS-mode exit sequence, data transmission through the Dp line and the Dn line is performed in the LP mode.

In this manner, the DSI-bus transmission circuit performs data transmission in the HS mode or in the LP mode. Note that as for the transmission paths through which the clock differential signals CKp/CKn are transmitted, in general, such switching between the HS mode and the LP mode is not performed.

<1.4.4 Display Operation with the DSI-Bus Transmission Circuit>

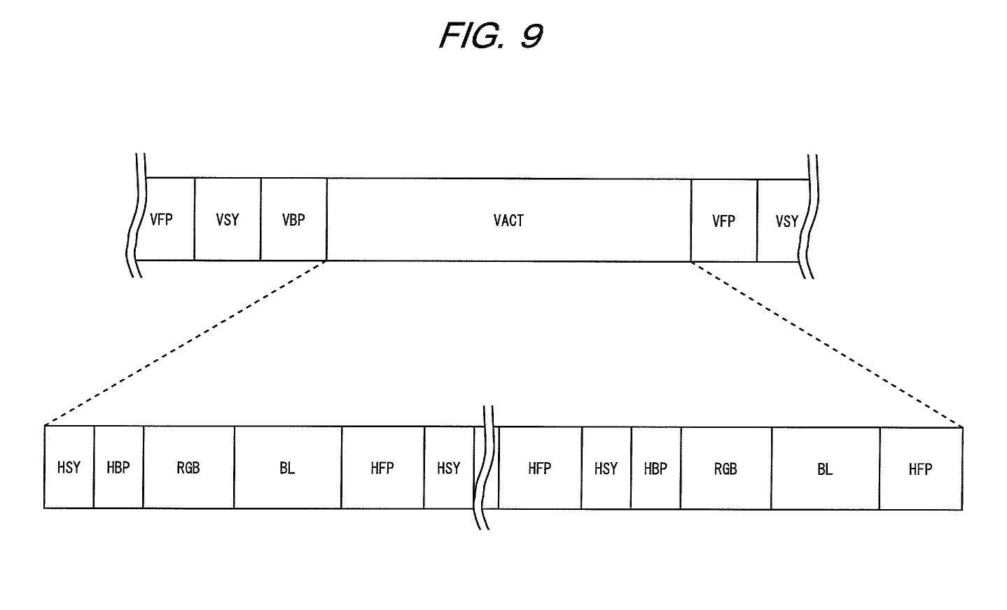

FIG. 9 is a schematic diagram describing a display operation using the DSI-bus transmission circuit. In FIG. 9, image display for one frame is realized by a vertical synchronization period VSY, a vertical back porch period VBP, a display period VACT, and a vertical front porch period VFP. In the display period VACT, a horizontal operation period HSY, a horizontal back porch period HBP, an image data transfer period RGB, a blanking period BL, and a horizontal front porch period HFP are repeated sequentially.

In the vertical synchronization period VSY, the vertical back porch period VBP, and the vertical front porch period VFP, data transmission is performed in the LP mode. Moreover, also in all of the periods within the display period VACT, excluding the image data transfer period RGB, i.e., in the horizontal operation period HSY, the horizontal back porch period HBP, the blanking period BL, and the horizontal front porch period HFP, data transmission is performed in the LP mode.

On the other hand, the image data transfer period RGB within the display period VACT, data transmission is performed in the HS mode. In the image data transfer period RGB, image data DAT is transmitted as data differential signals Dp/Dn. As a result, the image data DAT can be transmitted at high speed.

<1.5 SPI-Bus Transmission Circuit>

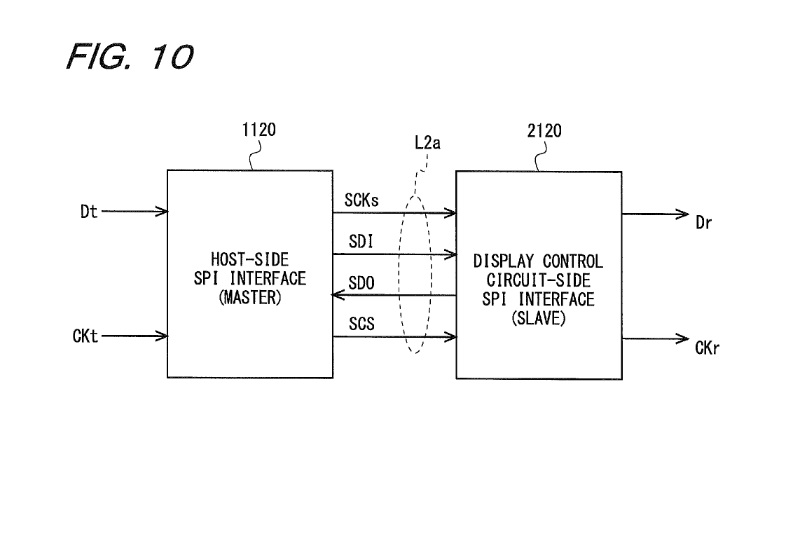

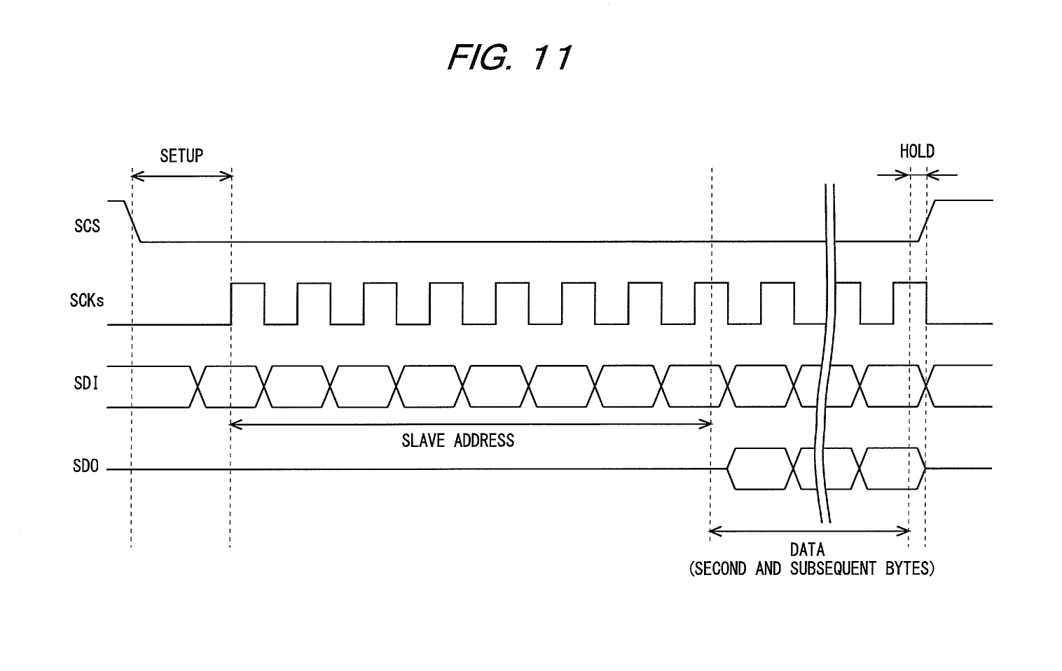

FIG. 10 is a block diagram illustrating the configuration of the SPI-bus transmission circuit in the present embodiment. The SPI-bus transmission circuit includes the host-side SPI interface (master) 1120, the SPI bus L2a, and the display control circuit-side SPI interface 2120 (slave), as described earlier. The SPI bus L2a includes four transmission paths through which to transmit an SPI clock SCKs, an input data signal SDI, an output data signal SDO, and a chip select signal SCS, respectively. The transmission paths through which to transmit the SPI clock SCKs, the input data signal SDI, the output data signal SDO, and the chip select signal SCS will be referred to below as the “SCKs line”, the “SDI line”, the “SDO line”, and the “SCS line”, respectively. The SPI clock SCKs, the input data signal SDI, the output data signal SDO, and the chip select signal SCS are transmitted by single-ended signaling. The SPI clock SCKs, the input data signal SDI, and the chip select signal are transmitted from the host-side SPI interface 1120 to the display control circuit-side SPI interface 2120. On the other hand, the output data signal SDO is transmitted from the display control circuit-side SPI interface 2120 to the host-side SPI interface 1120.

In the SPI-bus transmission circuit, transmission data Dt and a transmission clock CKt provided to the host-side SPI interface 1120 are transmitted to the display control circuit-side SPI interface 2120 via the SPI bus L2a, as shown in FIG. 10, and then outputted from the display control circuit-side SPI interface 2120 as reception data Dr and a reception clock CKr, respectively.

FIG. 11 is a signal waveform diagram describing signal transmission through the SPI-bus transmission circuit in the present embodiment. Data exchange between the host-side SPI interface 1120 and the display control circuit-side SPI interface 2120 is performed in synchronization with the SPI clock SCKs only when the chip select signal SCS is active (at low level).

Initially, the chip select signal SCS changes from high level to low level (i.e., it is activated). Next, once the SPI clock SCKs rises, the input data signal SDI is inputted at the rise of the SPI clock SCKs. The period that spans from the chip select signal SCS changing from high level to low level until the first time the SPI clock SCKs rises will be referred to as the “setup period”.

After the setup period, the input data signal SDI is inputted to the display control circuit-side SPI interface 2120 at the rise of the SPI clock SCKs. Here, data for the first one byte is data for a slave address, and the actual data transmission is performed from the second byte onward. The period from the second byte to the last bit will be referred to below as the “data transmission period”. In the data transmission period, the second and subsequent bytes of the input data signal SDI transmitted from the host-side SPI interface 1120 are inputted to the display control circuit-side SPI interface 2120 at the rise of the SPI clock SCKs, and the output data signal SDO transmitted from the display control circuit-side SPI interface 2120 is inputted to the host-side SPI interface 1120 at the rise of the SPI clock SCKs. Note that the SDO line is in high-impedance state except during the data transmission period.

After the data transmission period, the chip select signal SCS changes from low level to high level, so that the data exchange between the host-side SPI interface 1120 and the display control circuit-side SPI interface 2120 ends. The period from the end of the data transmission period until the chip select signal at low level changing to high level will be referred to as the “hold period”.

In this manner, data transmission through the SPI-bus transmission circuit is performed. Note that the SPI bus L2a can connect not only to the display control circuit-side SPI interface 2120 but also to a plurality of other slaves.

<1.6 I2C-Bus Transmission Circuit>

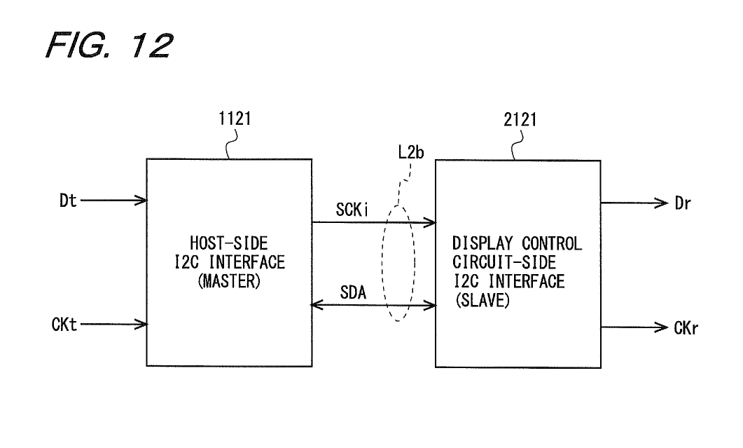

FIG. 12 is a block diagram illustrating the configuration of the I2C-bus transmission circuit in the present embodiment. The I2C-bus transmission circuit includes the host-side I2C interface (master) 1121, the I2C-bus L2b, and the display control circuit-side I2C interface (slave) 2121, as described earlier. The I2C-bus L2b includes two transmission paths through which to transmit an I2C clock SCKi and an input/output data signal SDA, respectively. The transmission paths through which to transmit an I2C clock SCKi and an input/output data signal SDA will be referred to below as the “SCKi line” and the “SDA line”, respectively. The I2C clock SCKi and the input/output data signal SDA are transmitted by single-ended signaling. The input/output data signal SDA is transmitted bidirectionally between the host-side I2C interface 1121 and the display control circuit-side I2C interface 2121.

In the I2C-bus transmission circuit, transmission data Dt and a transmission clock CKt provided to the host-side I2C interface 1121 are transmitted to the display control circuit-side I2C interface 2121 via the I2C-bus L2b, and outputted from the display control circuit-side I2C interface 2121 as reception data Dr and a reception clock CKr, respectively, as shown in FIG. 12.

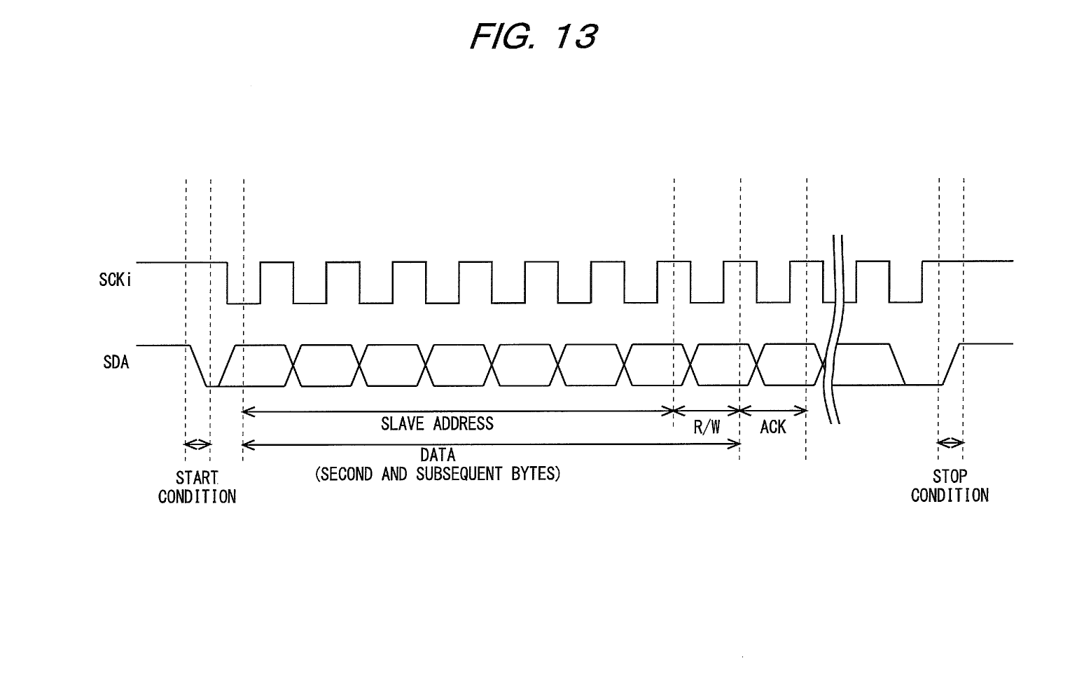

FIG. 13 is a signal waveform diagram describing signal transmission through the I2C-bus transmission circuit in the present embodiment. Data exchange between the host-side I2C interface 1121 and the display control circuit-side I2C interface 2121 is performed bidirectionally in a time-division manner only when the I2C clock SCKi is being supplied. A start condition and a stop condition, which indicate the start and the end, respectively, of communication, are provided before and after data transmission, respectively, as shown in FIG. 13. In the case where the SCKi line is at high level, when the SDA line changes from high level to low level, the start condition occurs. On the other hand, in the case where the SCKi line is at high level, when the SDA line changes from low level to high level, the stop condition occurs. Moreover, for each data transmission (in units of eight bits), an ACK bit, which indicates success or failure of data reception, is added as the ninth bit. An R/W bit, which is the eighth bit in data to be transmitted in a single operation, indicates the direction of data transmission.

In data transmission after the start condition, data for the first one byte is data for a slave address, and the actual data transmission is performed from the second byte onward. After the data is transmitted, the data transmission operation ends at the stop condition.

In this manner, data transmission through the I2C-bus transmission circuit is performed. Note that the I2C bus L2b can connect not only to the display control circuit-side I2C interface 2121 but also to a plurality of other slaves.

<1.7 Transition from Normal to Debug Mode>

The display control circuit 200 in the LCD driver 20 in the present embodiment can operate in two modes, i.e., normal and debug modes, as described earlier. Here, the “normal mode” in the present embodiment refers to a mode in which the liquid crystal display panel 30 displays a desired image on the basis of image data DAT and command data COM provided to the LCD driver 20 by the host 1 via the DSI-bus transmission circuit. On the other hand, the “debug mode” in the present embodiment refers to a mode in which the LCD driver 20 can be debugged using the single-ended bus L2 (SPI bus L2a and/or I2C-bus L2b). In the case where debugging is performed using the DSI bus L1 included in the DSI-bus transmission circuit, more expensive facilities and equipment than conventional are required, because the waveforms of signals to be transmitted through the DSI bus L1 are complicated. However, in the present embodiment, debugging can be performed using the single-ended bus L2, which transmits signals with simpler waveforms than the signals transmitted by the DSI bus L1 in the debug mode.

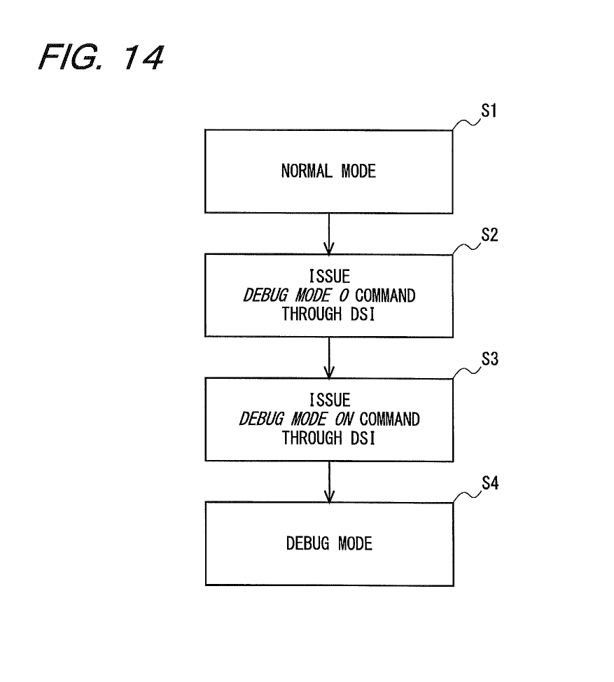

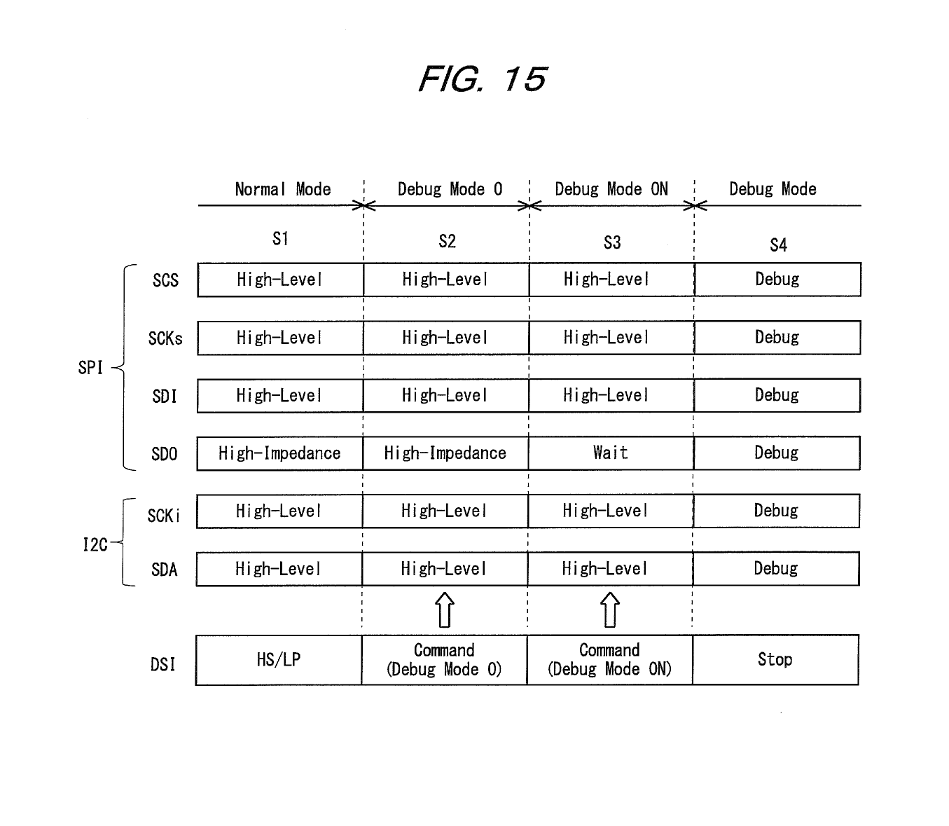

FIG. 14 is a flowchart describing the steps for a transition from normal to debug mode in the present embodiment. FIG. 15 is a scheme describing the status of each bus (SPI bus L2a, I2C-bus L2b, and DSI bus L1) at the transition from normal to debug mode in the present embodiment. Initially, in the normal mode (step S1), the liquid crystal display panel 30 is caused to display a desired image on the basis of image data DAT and command data COM provided to the LCD driver 20 by the host 1 via the DSI-bus transmission circuit, as described earlier. The status of the DSI bus L1 in the normal mode is HS or LP mode. Moreover, the SCS line, the SCKs line, the SDI line, the SCKi line, and the SDA line are fixed at high-level potential, and the SDO line is in high-impedance state, as shown in FIG. 15. In the normal mode, the high-level potential is provided externally (from the host 1), for example, via an FPC (Flexible Printed Circuit).

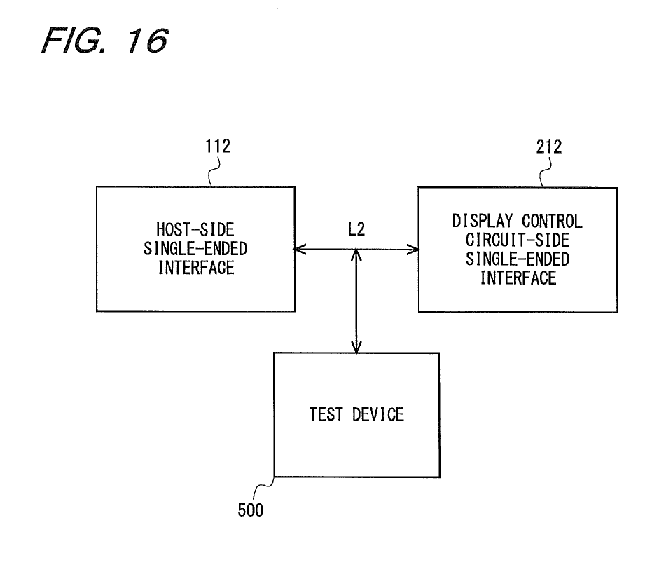

Next, a command to start debug mode 0, which is a preparation mode for transitioning from normal to debug mode, (referred to below as a debug mode 0 command”) is issued through the DSI bus L1 (step S2), as shown in FIGS. 14 and 15. More specifically, the host 1 issues the debug mode 0 command through the DSI bus L1. The debug mode 0 command may be issued either in the LP mode or in the HS mode. In debug mode 0, as in the normal mode, the SCS line, the SCKs line, the SDI line, the SCKi line, and the SDA line are fixed at high-level potential, and the SDO line is in high-impedance state. However, in debug mode 0, unlike in the normal mode, the high-level potential is provided from inside the LCD driver 20. Moreover, at the same time, the LCD driver 20 is brought into a state in which to accept no external signal (from the host 1) via the single-ended bus L2. In debug mode 0, preparations are made to connect a test device (such as an oscilloscope) 400 to the single-ended bus L2 for debugging, and the test device is electrically connected to the single-ended bus L2, as shown in FIG. 16.

Next, a command to start debug mode ON, which is a mode in which to transition from normal to debug mode, (referred to below as a debug mode ON command”) is issued through the DSI bus L1 (step S3), as shown in FIGS. 14 and 15. More specifically, the host 1 issues the debug mode ON command through the DSI bus L1. The debug mode ON command may be issued either in the LP mode or in the HS mode. In debug mode ON, as in the normal mode and debug mode 0, the SCS line, the SCKs line, the SDI line, the SCKi line, and the SDA line are fixed at high-level potential. However, in this debug mode, unlike in the normal mode and debug mode 0, the high-level potential is provided by the test device 500. Note that the provision of the high-level potential from inside the LCD driver 20 is stopped in accordance with the debug mode ON command. Moreover, unlike in the normal mode and debug mode 0, the SDO line is brought into a state to wait for an output from the LCD driver 20 (display control circuit-side SPI interface 2120). After debug mode ON, transitioning to the debug mode is brought about.

In the debug mode, debugging is started by the test device 500 issuing a command to start debugging, through the single-ended bus L2, as shown in FIG. 15. More specifically, the test device 500 provides a test pattern to the single-ended bus L2, and checks the transmission status of the test pattern to perform debugging. In the debug mode, the DSI bus L1 is in stop mode, but it may be in the HS or LP mode.

As described above, in the present embodiment, debugging can be performed using the single-ended bus L2. Note that transitioning from debug to normal mode is realized, for example, by the test device 500 issuing a command to stop debugging through the single-ended bus L2 and, thereafter, the host 1 issuing a command for a transition to the normal mode through the DSI bus L1 (referred to below as a “normal mode ON command”).

<1.8 Practical Example>

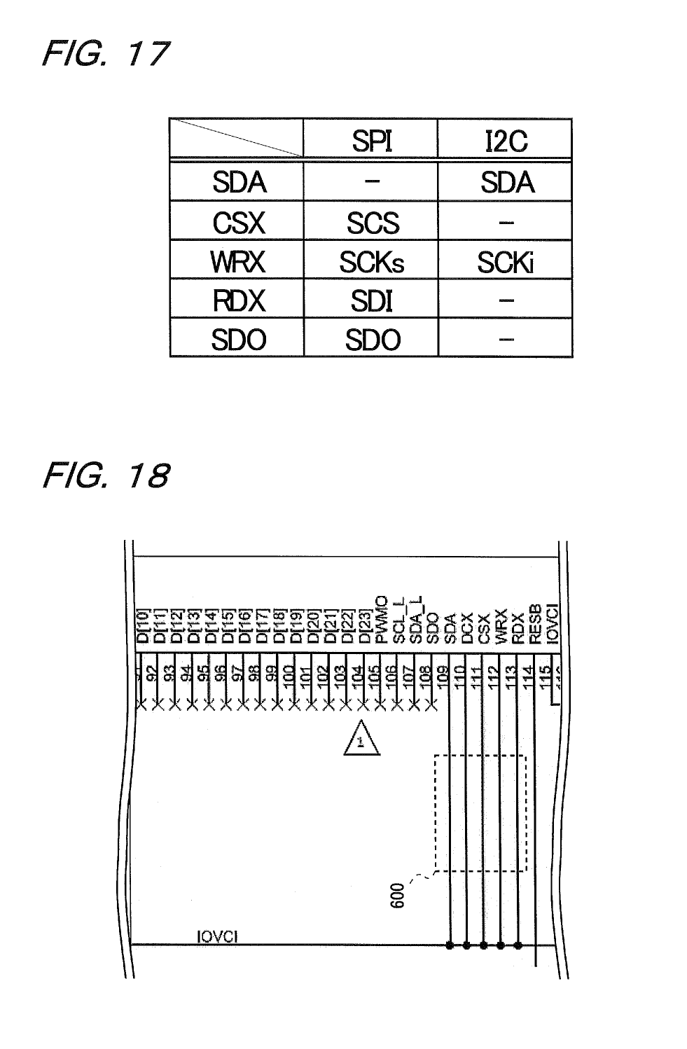

FIG. 17 is a diagram showing the correspondence between terminals and buses in the LCD driver 20 (display control circuit-side single-ended interface 212) in a practical example of the present embodiment. In this practical example, the LCD driver 20 is provided with an SDA terminal, a CSX terminal, a WRX terminal, an RDX terminal, and an SDO terminal. The CSX terminal, the WRX terminal, the RDX terminal, and the SDO terminal correspond to the SCS line, the SCKs line, the SDI line, and the SDO line, respectively, of the SPI bus L2a, as shown in FIG. 17. Moreover, the SDA terminal and the WRX terminal correspond to the SDA line and the SCKi line, respectively, of the I2C-bus L2b. That is, the WRX terminal is shared between the SCKs line and the SCKi line.

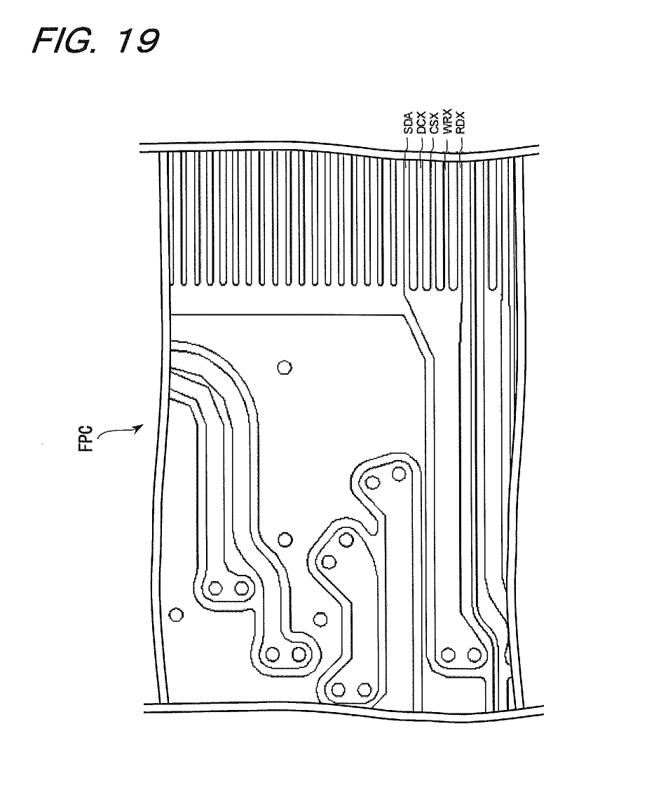

FIG. 18 is a block diagram illustrating in part an example of the wiring in the practical example. FIG. 19 is a diagram illustrating an FPC pattern corresponding to the block diagram shown in FIG. 18. The SDA terminal, the CSX terminal, the WRX terminal, the RDX terminal, and the SDO terminal of the LCD driver 20 are provided with an IOVCI signal, which is at high-level potential, externally (from the host 1) via a wiring group 600 (FPC), as shown in FIG. 18. The test device 500 is connected to the wiring group 600 at the time of debug mode 0. Specifically, at the time of debug mode 0, an operation of, for example, cutting the FPC pattern or removing a jumper resistor (0-Ω resistor) previously provided on the wiring group 600 is performed on the FPC, and thereafter, the test device 500 is connected to the portion where the pattern was cut or the jumper resistor was removed. Note that from the viewpoint of ease of operation, the form with the jumper resistor is more desirable.

<1.9 Effects>

In the present embodiment, the LCD driver 20, which supports the DSI specification, can transition to the debug mode, which is a mode dedicated to debugging, from the normal mode, which is a mode in which the liquid crystal display panel 30 displays a desired image on the basis of image data DAT and command data COM provided to the LCD driver 20 by the host 1 via the DSI-bus transmission circuit. In the debug mode, debugging can be performed using a single-ended serial bus (an SPI bus or an I2C bus) connected to the LCD driver 20. The waveforms of signals to be transmitted through the SPI bus or the I2C bus are simpler than the waveforms of signals to be transmitted through the DSI bus, and therefore, it is possible to perform a waveform analysis using conventional facilities and equipment. Thus, easy debugging can be achieved at low cost.

<1.10 Variant>

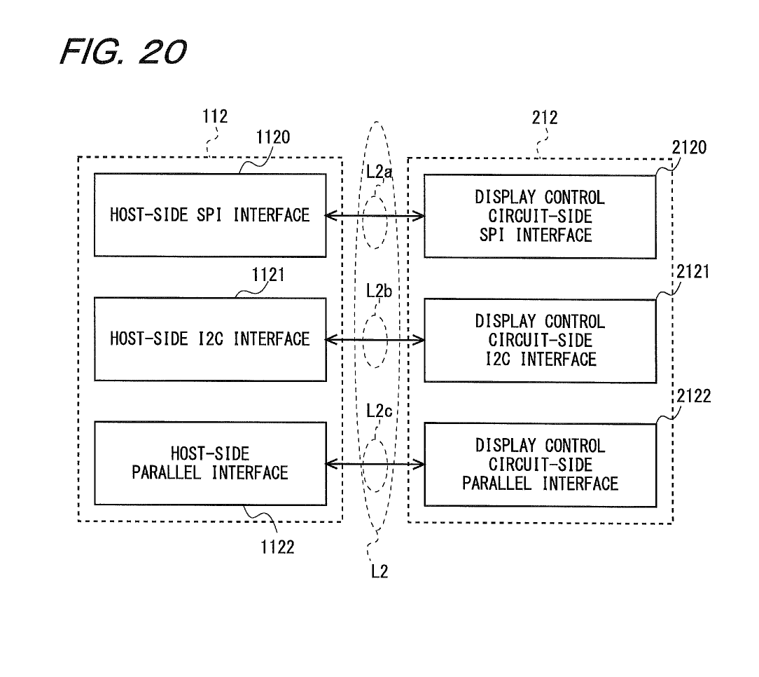

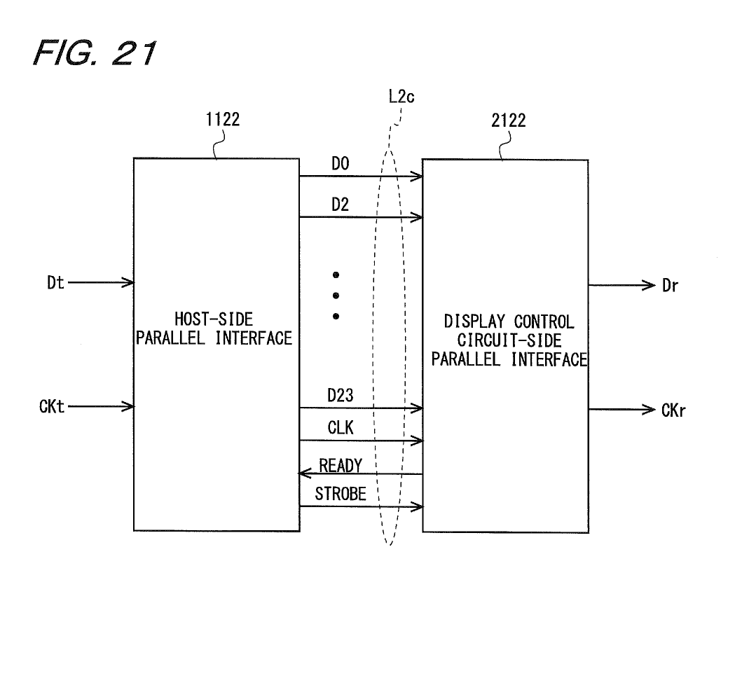

FIG. 20 is a block diagram describing the configuration of the display control circuit-side DSI interface 211 in a variant of the first embodiment of the present invention. In the present variant, the display control circuit-side single-ended interface 212 further includes a display control circuit-side parallel interface 2122, as shown in FIG. 20. Likewise, the host-side single-ended interface 112 further includes a host-side parallel interface 1122, and the single-ended bus L2 further includes a parallel bus L2c. The host-side parallel interface 1122, the parallel bus L2c, and the display control circuit-side parallel interface 2122 realize a parallel bus transmission circuit. Note that the parallel bus transmission circuit is a transmission circuit for use in the debug mode, and therefore, the host-side parallel interface 1122 and the display control circuit-side parallel interface 2122 are not necessarily connected to each other at all times, but they are connected at least during the debug mode.

FIG. 21 is a block diagram illustrating the configuration of the parallel bus transmission circuit in the present variant. The parallel bus L2c consists of 27 transmission paths through which a parallel clock signal CLK, data signals, e.g., 24 bits of data D0 to D23, a READY signal, and a STROBE signal are respectively transmitted. The data signals D0 to D23 for 24 bits, the READY signal, and the STROBE signal are transmitted by single-ended signaling. In the parallel bus transmission circuit, transmission data Dt and a transmission clock CKt provided to the host-side parallel interface 1122 are transmitted in parallel to the display control circuit-side parallel interface 2122 via the parallel bus L2c, and the display control circuit-side parallel interface 2122 outputs them as reception data Dr and a reception clock CKr.

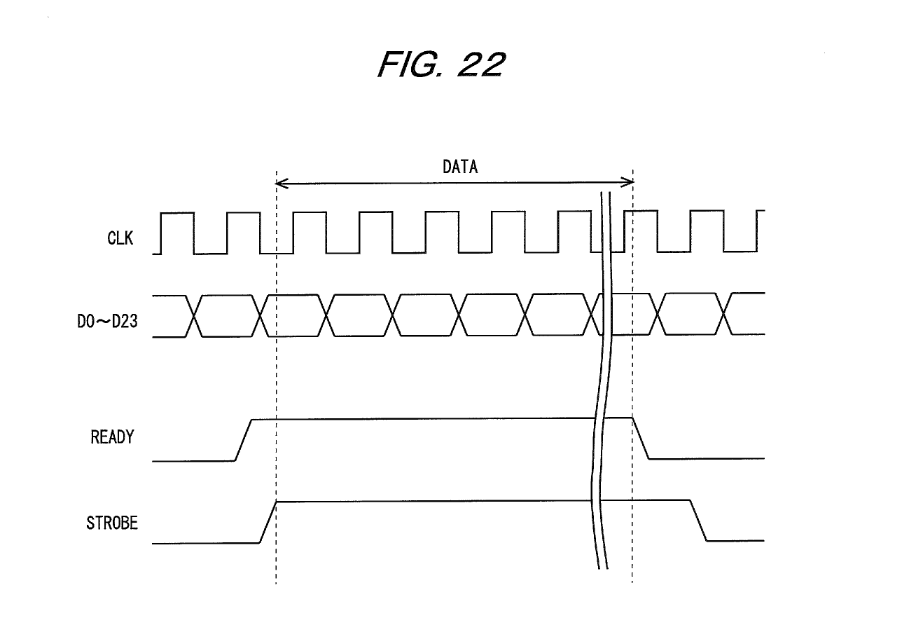

FIG. 22 is a signal waveform diagram describing signal transmission through the parallel bus transmission circuit in the present variant. The data signals D0 to D23 are transmitted from the host-side parallel interface 1122 to the display control circuit-side parallel interface 2122 while both the READY signal and the STROBE signal are at high level.

The present variant allows not only a serial bus but also a parallel bus to be used for debugging.

### 2. Second Embodiment

<2.1 Configuration of the Host Input/Output Portion>

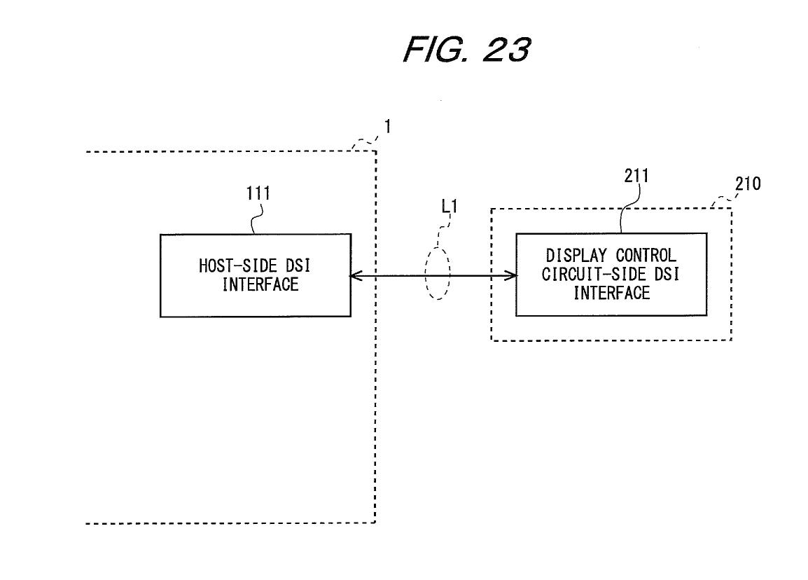

FIG. 23 is a block diagram describing the configuration of the host input/output portion 210 in a second embodiment of the present invention. Note that the present embodiment is the same as the first embodiment, except for the host input/output portion 210, the transition from normal to debug mode, and the image signal generating portion 224, and any descriptions of common points therebetween will be omitted. In the present embodiment, the host input/output portion 210 has only the display control circuit-side DSI interface 211 provided therein, and the display control circuit-side single-ended interface 212 is not provided therein, as shown in FIG. 23. That is, the DSI-bus transmission circuit (host-side DSI interface 111, DSI bus L1, and display control circuit-side DSI interface 211) is the only bus transmission circuit provided in the present embodiment. However, in the present embodiment also, the SPI-bus transmission circuit, the I2C-bus transmission circuit, and the parallel bus transmission circuit may be provided as well.

<2.2 Transition from Normal to Debug Mode>

In the present embodiment, the “debug mode” refers to a mode in which debugging is rendered possible by displaying register data Dre (such as command data COM) stored in the register 222 on the liquid crystal display panel 30 as an image. Note that the normal mode in the present embodiment is the same as in the first embodiment.

In the first embodiment, transitioning from normal to debug mode is realized by debug mode 0, which is a preparation mode for transitioning from normal to debug mode, and debug mode ON, which is a mode in which to transition from normal to debug mode, but in the present embodiment, it is realized simply by debug mode ON. Accordingly, in the present embodiment, there is only one command for a transition from normal to debug mode, i.e., a debug mode ON command. Note that transitioning from debug to normal mode is realized by the host 1 issuing a normal mode ON command.

<2.3 Configuration of the Image Signal Generating Portion>

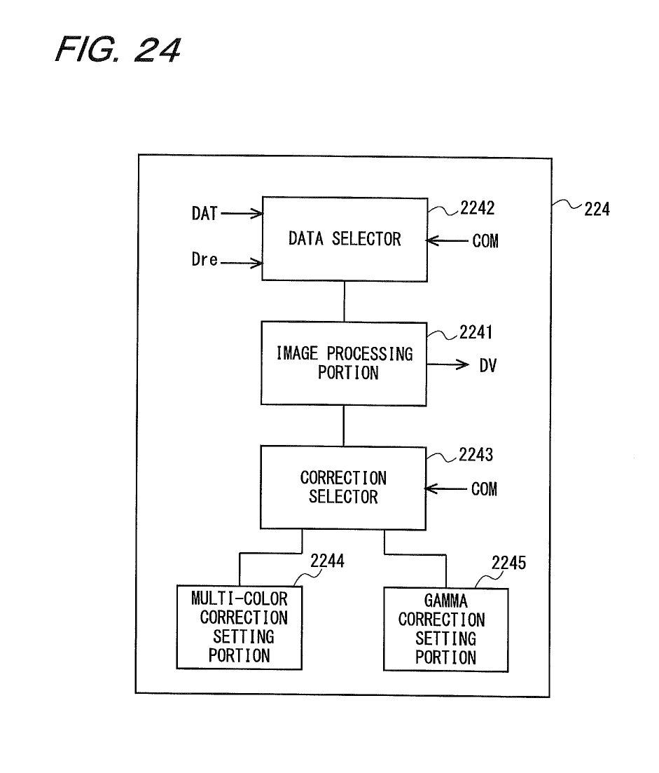

FIG. 24 is a block diagram illustrating the configuration of the image signal generating portion 224 in the signal processing portion 220 in the present embodiment. The image signal generating portion 224 includes an image processing portion 2241, a data selector 2242, a correction selector 2243, a multi-color correction setting portion (first setting portion) 2244, and a gamma correction setting portion (second setting portion) 2245, as shown in FIG. 24. The image processing portion 2241 is connected to the data selector 2242 and the correction selector 2243. The correction selector 2243 is connected to the multi-color correction setting portion 2244 and the gamma correction setting portion 2245.

The image processing portion 2241 generates an image signal DV by correcting image signal generation data GDAT provided by the data selector 2242 in accordance with a setting selected by the correction selector 2243.

On the basis of the command data COM provided by the host 1 via the DSI-bus transmission circuit, the data selector 2242 selects image data DAT, or register data Dre (such as command data COM) stored in the register 222, as a signal to be provided to the image processing portion 2241. More specifically, the data selector 2242 provides the image data DAT to the image processing portion 2241 as image signal generation data GDAT during a period after issuance of a normal mode ON command but before issuance of a debug mode ON command, and also provides the register data Dre to the image processing portion 2241 as image signal generation data GDAT during a period after issuance of a debug mode ON command but before issuance of a normal mode ON command.

On the basis of the command data COM, the correction selector 2243 selects the multi-color correction setting portion 2244 or the gamma correction setting portion 2245 as a reference source for the setting of a correction to be performed on the signal received by the image processing portion 2241 (hereinafter, simply referred to as a “reference source”). More specifically, the correction selector 2243 uses the gamma correction setting portion 2245 as the reference source during a period after issuance of a normal mode ON command but before issuance of a debug mode ON command, and also uses the gamma correction setting portion 2245 as the reference source during a period after issuance of a debug mode ON command but before issuance of a normal mode ON command.

The multi-color correction setting portion 2244 has a correction table stored therein, for example, to convert data received by the image processing portion 2241 into two-color data. The register data Dre consists of, for example, eight bytes (=64 bits), and therefore, is corrected so as to represent each of the 64 bits either in white or black. The multi-color correction setting portion 2244 realizes a first setting.

The gamma correction setting portion 2245 has a correction table stored therein, for example, to subject data received by the image processing portion 2241 to a gray-level correction based on the gamma characteristics of the liquid crystal display panel 30. The gamma correction setting portion 2245 realizes a second setting.

The image signal generating portion 224 will be described with respect to its operation in the normal mode first. The normal mode falls in the period after issuance of a normal mode ON command but before issuance of a debug mode ON command. In this period, the data selector 2242 provides image data DAT to the image processing portion 2241, and the correction selector 2243 selects the gamma correction setting portion 2245 as the reference source. As a result, the image processing portion 2241 generates an image signal DV by correcting the image data DAT in accordance with the setting by the gamma correction setting portion 2245. The logic controller 221 provides the image signal DV to the source driver 310 via the driver output portion 230.

Next, the operation of the image signal generating portion 224 in the debug mode will be described. The debug mode falls in the period after issuance of a debug mode ON command but before issuance of a normal mode ON command. In this period, the data selector 2242 provides register data Dre to the image processing portion 2241, and the correction selector 2243 selects the multi-color correction setting portion 2244 as the reference source. As a result, the image processing portion 2241 generates an image signal DV by correcting the register data Ere in accordance with the setting by the multi-color correction setting portion 2244. More specifically, the image signal DV is generated by converting each bit included in the register data Ere into 8-bit data representing white or black. Note that the conversion is not limited to 8-bit data, and conversion into, for example, 16-bit data may be performed. The logic controller 221 provides the image signal DV to the source driver 310 via the driver output portion 230. As a result, in the debug mode, the liquid crystal display panel 30 displays an image based on the register data Dre.

<2.4 Display Example in the Debug Mode>

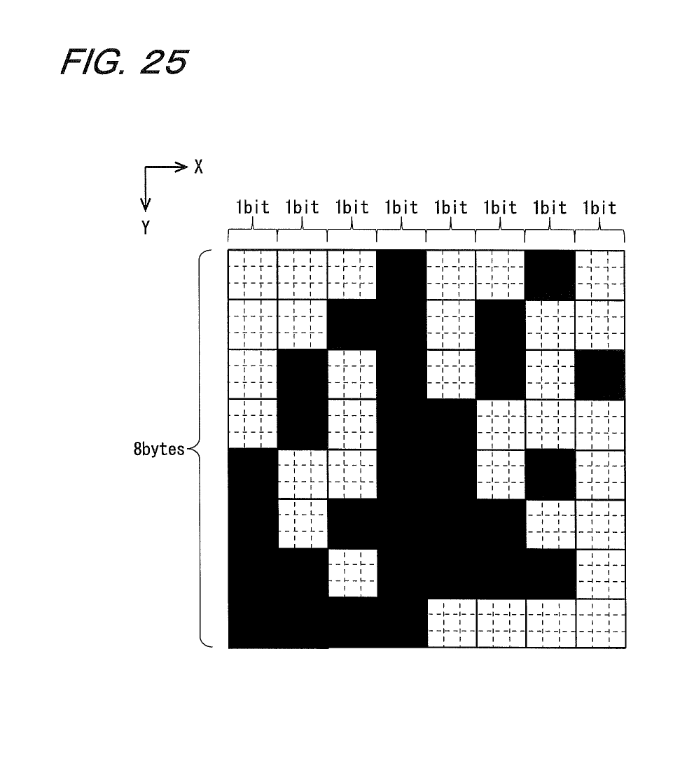

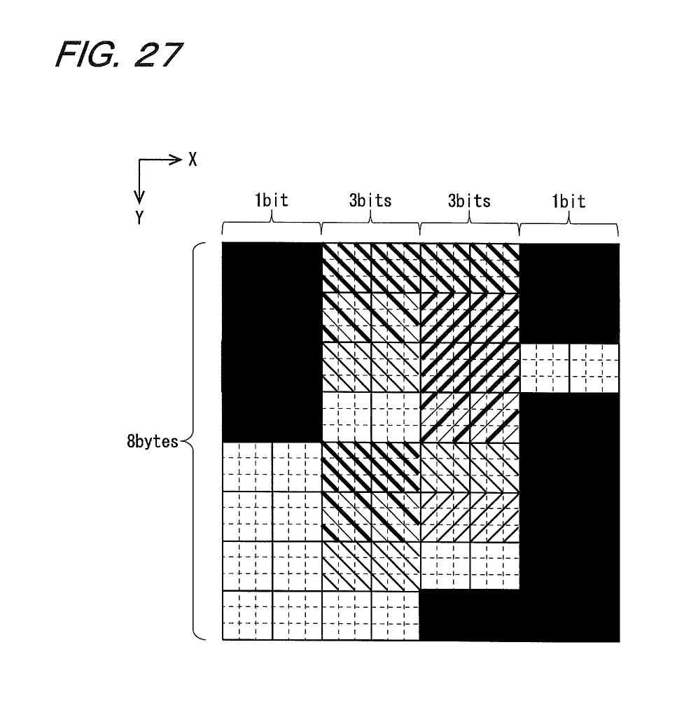

FIG. 25 is a schematic diagram showing an exemplary image based on register data Dre displayed on the liquid crystal display panel 30 in the debug mode. In FIG. 25, each broken-lined square represents a pixel. That is, the display example shown is 24 pixels×24 pixels (the same applies to FIG. 27 to be described later). However, this number of pixels is illustrative, and is not intended to limit the present invention. In FIG. 25, each solid-lined square (nine pixels) represents one bit, where white represents 0 and black represents 1. Moreover, in FIG. 25, arrows denote X and Y directions. In the following, an array of squares arranged in the X direction will be referred to as a “row”. In this example, eight bytes (=64 bits) of register data Dre are displayed in black and white. Each row represents a byte of information in the register data Dre. For example, the first row represents “00010010”, and the fifth row represents “10011010”.

<2.5 Effects>

In the present embodiment, the LCD driver 20, which supports the DSI specification, can transition to the debug mode, which is a mode dedicated to debugging, from the normal mode, which is a mode in which the liquid crystal display panel 30 displays a desired image on the basis of image data DAT and command data COM provided to the LCD driver 20 by the host 1 via the DSI-bus transmission circuit. In the debug mode, the liquid crystal display panel 30 displays register data Dre, which is stored in the register 222 in the signal processing portion 220, as an image. Thus, debugging can be performed by visually checking the image or reading the image with a scanner or suchlike. Thus, easy debugging can be achieved at low cost.

Furthermore, in the present embodiment, the correction selector 2243 selects the gamma correction setting portion 2245 as the reference source in the normal mode, and the multi-color correction setting portion 2244 as the reference source in the debug mode. Thus, image display can be provided reliably both in the normal mode and in the debug mode.

<2.6 Variant>

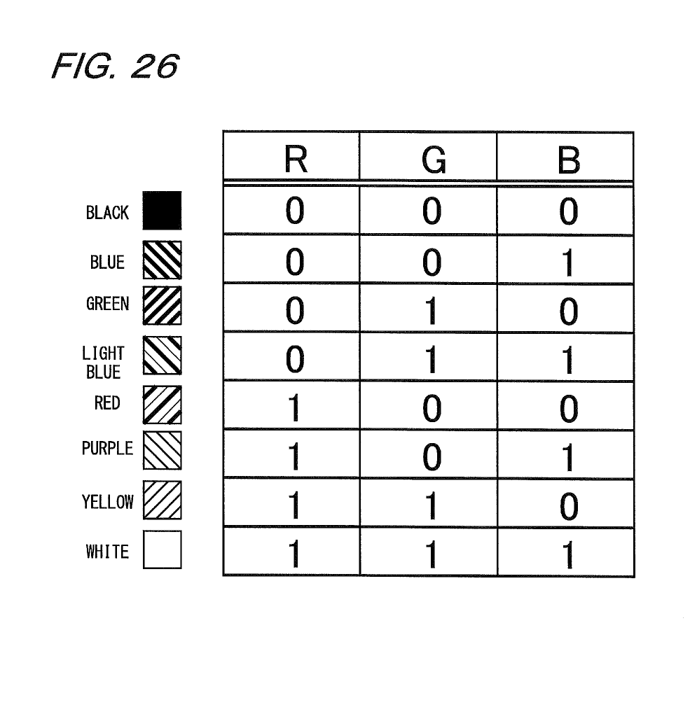

In a variant of the second embodiment of the present invention, unlike in the second embodiment, register data Dre is displayed in eight colors in the debug mode. FIG. 26 is a diagram showing the correspondence between sets of three bits in the register data Dre and colors to be assigned thereto in the present variant. In the present variant, the sets of three bits in the register data Dre can be expressed in eight colors. Specifically, “black” is assigned to the three bits “000”, “blue” is assigned to “001”, “green” is assigned to “010”, “light blue” is assigned to “011”, “red” is assigned to“100”, “purple” is assigned” to “101”, “yellow” is assigned to “110”, and “white” is assigned to “111”, as shown in FIG. 26. Note that in FIG. 26 and in FIG. 27 to be described later, the colors other than white and black are indicated in hatching. Note that the colors to be assigned to data and the number of display colors in the present variant are not limiting.

FIG. 27 is a schematic diagram showing an exemplary image based on register data Dre displayed on the liquid crystal display panel 30 in the debug mode in the present variant. In each row of FIG. 27, two solid-lined squares positioned on the left and right sides in the figure represent one bit each, and two solid-lined squares positioned at the left center and the right center in the figure represent three bits each. Note that for the two solid-lined squares positioned on the left and right sides in the figure, white and black represent 0 and 1, as in the second embodiment. In this example, eight bytes (=64 bits) of register data Dre are displayed in eight colors. Each row represents a byte of information in the register data Dre. For example, the first row represents “10010011”, and the fifth row represents “00011011”.

In the present variant, debugging can be performed by visually checking an image displayed in eight colors on the liquid crystal display panel 30 or reading the image with a scanner or suchlike.

### <3. Third Embodiment>

<3.1 Configuration of the Image Signal Generating Portion>

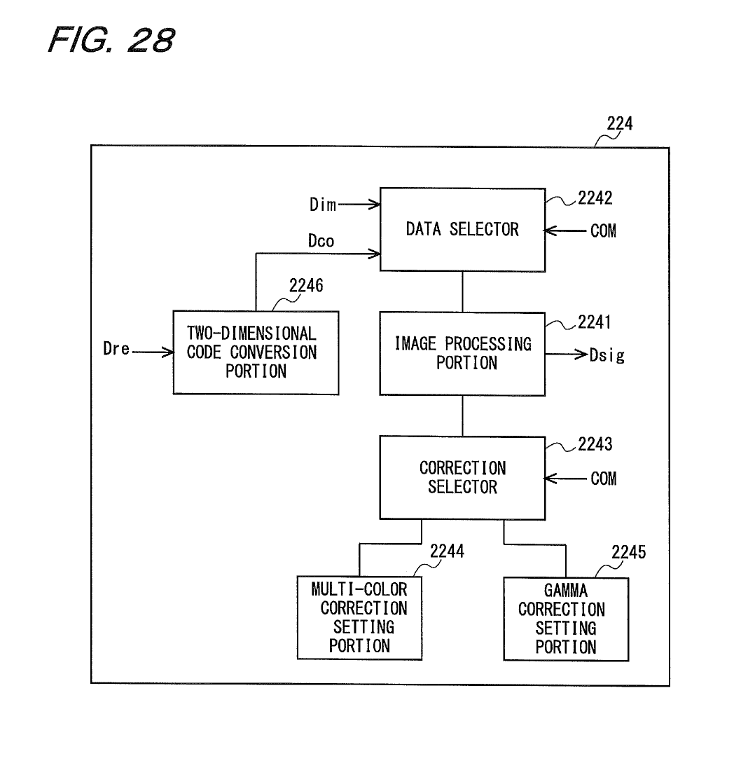

FIG. 28 is a block diagram illustrating the configuration of the image signal generating portion 224 in the signal processing portion 220 in a third embodiment of the present invention. Note that the present embodiment is the same as the second embodiment except for a two-dimensional code conversion portion 2246 to be described later, and any descriptions of common points therebetween will be omitted. The image signal generating portion 224 in the present embodiment has the two-dimensional code conversion portion 2246 added to the image signal generating portion 224 in the second embodiment, as shown in FIG. 28.

The two-dimensional code conversion portion 2246 is provided with register data Dre (such as command data COM) stored in the register 222. The two-dimensional code conversion portion 2246 converts the provided register data Dre (binary code) into a two-dimensional code Dco arranged within a two-dimensional matrix as a pattern. Such conversion into a two-dimensional code Dco is realized by the technology described in Patent Document 3.

The data selector 2242 selects image data DAT or a two-dimensional code Dco as a signal to be provided to the image processing portion 2241, on the basis of command data COM provided by the host 1 via the DSI-bus transmission circuit. More specifically, the data selector 2242 provides the image data DAT to the image processing portion 2241 during a period after issuance of a normal mode ON command but before issuance of a debug mode ON command, and also provides the two-dimensional code Dco to the image processing portion 2241 during a period after issuance of a debug mode ON command but before issuance of a normal mode ON command. Note that the operation of the correction selector 2243 is the same as in the second embodiment.

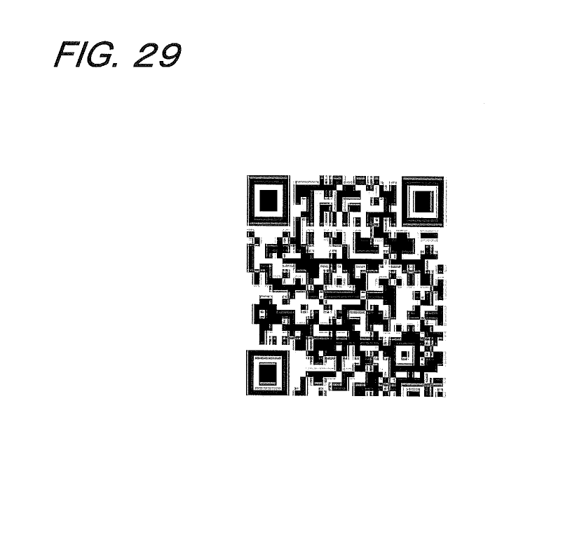

In the present embodiment, the operation of the image signal generating portion 224 in the normal mode is the same as in the second embodiment, and therefore, only the operation of the image signal generating portion 224 in the debug mode will be described. The debug mode falls in the period after issuance of a debug mode ON command but before issuance of a normal mode ON command. In this period, the data selector 2242 provides a two-dimensional code Dco to the image processing portion 2241, and the correction selector 2243 selects the multi-color correction setting portion 2244 as the reference source. As a result, the image processing portion 2241 generates an image signal DV by correcting the two-dimensional code Dco in accordance with the setting by the multi-color correction setting portion 2244. The logic controller 221 provides the image signal DV to the source driver 310 via the driver output portion 230. As a result, in the debug mode, the liquid crystal display panel 30 displays an image based on the two-dimensional code Dco, as shown in, for example, FIG. 29.

<3.2 Effects>

In the present embodiment, the liquid crystal display panel 30 displays a two-dimensional code Dco as an image in the debug mode. The two-dimensional code Dco can be read with a scanner or suchlike even if the size thereof is small. Thus, debugging can be performed more readily than in the second embodiment.

### 4. Others

In the first embodiment, the data differential signals Dp/Dn transmitted by the DSI-bus transmission circuit have been described as one-phase signals, but the data differential signals Dp/Dn transmitted by the DSI-bus transmission circuit may be, for example, two- to four-phase signals.

In the first embodiment, the display control circuit-side single-ended interface 212 has been described as consisting of the display control circuit-side SPI interface 2120 and the display control circuit-side I2C interface 2121, but the present invention is not limited to this. The display control circuit-side single-ended interface 212 may consist of at least one of the display control circuit-side SPI interface 2120, the display control circuit-side I2C interface 2121, and the display control circuit-side parallel interface 2122 in the variant of the first embodiment.

The register data Dre is displayed on the liquid crystal display panel 30 as an image in two colors, black and white, or in eight colors in the second embodiment, or as a two-dimensional code Dco in the third embodiment, but these display methods are not limiting, and other display methods may be used.

Each of the embodiments has been described taking the liquid crystal display device as an example, but the present invention is not limited to this. The present invention can be applied to other display devices such as organic EL (Electro Luminescence) display devices.

Furthermore, various modifications can be made to the embodiments without departing from the spirit of the invention.

Thus, it is possible to provide a semiconductor integrated device, a display device, and a debugging method for a semiconductor integrated device which support a high-speed serial interface specification, and allow easy debugging to be achieved at low cost.

### INDUSTRIAL APPLICABILITY

The present invention can be applied to semiconductor integrated devices that support the DSI specification.

### DESCRIPTION OF THE REFERENCE CHARACTERS

1 host

2 liquid crystal display device

20 LCD driver (semiconductor integrated device)

30 liquid crystal display panel

200 display control circuit (display control portion)

210 host input/output portion

211 display control circuit-side DSI interface (first interface)

212 display control circuit-side single-ended interface (second interface)

220 signal processing portion

221 logic controller

222 register

223 control signal generating portion

224 image signal generating portion

230 driver output portion

300 driver group (drive portion)

310 source driver

320 gate driver

400 RAM

2120 display control circuit-side SPI interface (serial interface)

2121 display control circuit-side I2C interface (serial interface)

2122 display control circuit-side parallel interface

2241 image processing portion

2242 data selector (first selector)

2243 correction selector (second selector)

2244 multi-color correction setting portion (first setting portion)

2245 gamma correction setting portion (second setting portion)

L1 DSI bus (first bus)

L2 single-ended bus (second bus)

L2a SPI bus

L2b I2C-bus

L2c parallel bus

1. A semiconductor integrated device comprising:
a display control portion for controlling image display on an external display panel, wherein,
the display control portion includes:
a first interface connected to a first bus connectable to an external device, the first interface being capable of serially receiving a signal group transmitted through the first bus and consisting of a differential signal and a first single-ended signal; and
a signal processing portion connected to the first interface for generating a control signal and an image signal on the basis of the signal group received by the first interface, the control signal controlling image display on the display panel, the image signal corresponding to an image to be displayed on the display panel,
the first interface is capable of receiving a first command to switch operation modes of the display control portion, the first command being issued through the first bus by an external host connected to the first bus, and
the operation mode of the display control portion transitions to a debug mode allowing debugging to be performed without using the first bus, in accordance with the first command.

2. The semiconductor integrated device according to claim 1, wherein the first interface is an interface based on the DSI specification.

3. The semiconductor integrated device according to claim 1, wherein,
the display control portion further includes a second interface connected to a second bus connectable to an external device, the second interface being capable of receiving a second single-ended signal transmitted through the second bus, and
in the debug mode, the debugging is allowed to be performed using a signal transmitted through the second bus, in accordance with a second command issued through the second bus.

4. The semiconductor integrated device according to claim 3, wherein the second interface includes a serial interface capable of serially receiving the second single-ended signal.

5. The semiconductor integrated device according to claim 4, wherein the serial interface is an interface based on the SPI specification.

6. The semiconductor integrated device according to claim 4, wherein the serial interface is an interface based on the I2C specification.

7. The semiconductor integrated device according to claim 3, wherein the second interface includes a parallel interface capable of receiving the second single-ended signal in parallel.

8. The semiconductor integrated device according to claim 1, wherein,
the signal processing portion includes:
a register for storing command data to control an operation of the signal processing portion, the data being received from the host via the first interface; and
an image signal generating portion for generating the image signal, and
the image signal generating portion includes:
an image processing portion for generating the image signal on the basis of image signal generation data for use in generating the image signal; and
a first selector for providing the image signal generation data to the image processing portion, the image signal generation data being the command data when the operation mode of the display control portion is the debug mode, and the image signal generation data being data received from the host via the first interface and corresponding to the image to be displayed on the display panel when the operation mode of the display control portion is not the debug mode.

9. The semiconductor integrated device according to claim 8, wherein,
the image processing portion corrects the image signal generation data in accordance with a predetermined setting,
the image signal generating portion further includes a second selector using a first setting as the predetermined setting when the operation mode of the display control portion is the debug mode, and using a second setting as the predetermined setting when the operation mode of the display control portion is not the debug mode,
the first setting is a setting for correcting the image signal generation data into data in at least two colors, and
the second setting is a setting for correcting a gray-scale level of the image signal generation data on the basis of gamma characteristics of the display panel.

10. The semiconductor integrated device according to claim 8, wherein the image signal generating portion further includes a two-dimensional code conversion portion for converting the command data to be provided to the image processing portion via the first selector into a two-dimensional code.

11. The semiconductor integrated device according to claim 1, further comprising a drive portion connected to the display control portion for driving the display panel on the basis of the control signal and the image signal.

12. A display device comprising:
a semiconductor integrated device of claim 11; and
the display panel.

13. A display device comprising:
a semiconductor integrated device of claim 1;
the display panel; and
a drive portion connected to the display control portion for driving the display panel on the basis of the control signal and the image signal.

14. A debugging method for a semiconductor integrated device comprising a display control portion including a first interface connected to a first bus connectable to an external device, and a signal processing portion connected to the first interface, the first interface being capable of serially receiving a signal group transmitted through the first bus and consisting of a differential signal and a first single-ended signal, the signal processing portion generating a control signal and an image signal on the basis of the signal group received by the first interface, the control signal controlling image display on an external display panel, the image signal corresponding to an image to be displayed on the display panel, the method comprising the steps of:
receiving a first command to switch operation modes of the display control portion, the first command being issued through the first bus by an external host connected to the first bus; and
causing the operation mode of the display control portion to transition to a debug mode allowing debugging to be performed without using the first bus, in accordance with the first command.

15. The debug method according to claim 14, wherein,
the display control portion further includes a second interface connected to a second bus connectable to an external device, the second interface being capable of receiving a second single-ended signal transmitted through the second bus, and
the method further comprises the step of, when the operation mode of the display control portion is the debug mode, performing the debugging using a signal transmitted through the second bus, in accordance with a second command issued through the second bus.

16. The debug method according to claim 14, wherein,
the signal processing portion includes a register for storing command data to control an operation of the signal processing portion, the data being received from the host via the first interface, and
the method further comprises the step of generating the image signal on the basis of the command data when the operation mode of the display control portion is the debug mode, and on the basis of data received from the host via the first interface and corresponding to the image to be displayed on the display panel when the operation mode of the display control portion is not the debug mode.
